(19) United States
(12) Patent Application Publication
(10) Pub. No.: US 2021/0276551 A1
(43) Pub. Date: Sep. 9, 2021

(54) INFORMATION PROCESSING SYSTEM FOR MOVABLE OBJECTS AND INFORMATION PROCESSING METHOD FOR MOVABLE OBJECTS

(71) Applicant: HONDA MOTOR CO., LTD., Tokyo (JP)

(72) Inventors: Shigeru INOUE, Wako-shi (JP); Hideki MATSUNAGA, Wako-shi (JP); Masamitsu TSUCHIYA, Wako-shi (JP); Kenji KOMORI, Wako-shi (JP); Takahiro KUREHASHI, Wako-shi (JP); Hiroki TANAKA, Wako-shi (JP)

(21) Appl. No.: 17/188,169

(22) Filed: Mar. 1, 2021

(30) Foreign Application Priority Data
Mar. 3, 2020 (JP) 2020-035908
Mar. 3, 2020 (JP) 2020-035909

(51) Int. Cl. B60W 30/16; B60W 40/06

(52) U.S. Cl. CPC B60W 30/16; G06K 9/00798; B60W 40/06

(57) ABSTRACT

An information processing system for movable objects includes a processor comprising an information receiving section receiving information on a distance from a rear end of a most rearward first movable object in a row of plural first movable objects on a road to a movable object stopping prohibited area and a length of a second movable object that is stopping behind the most rearward first movable object, a determining section determining whether the distance and the length that are received by the information receiving section meet a predetermined condition, and a signal sending section sending the plural first movable objects forming the row a signal including a first instruction to instruct the plural first movable objects to shorten a gap distance between movable objects next to each other to a first distance, if the first determining section determines that the distance and the length meet the predetermined condition.

### CROSS REFERENCE TO RELATED APPLICATIONS

This application claims the foreign priority benefit under 35 U.S.C. § 119 of Japanese Patent Application No. 2020-035908 filed on Mar. 3, 2020 and Japanese Patent Application No. 2020-035909 filed on Mar. 3, 2020, the disclosure of which are incorporated herein by reference.

### TECHNICAL FIELD OF THE INVENTION

The present invention relates to an information processing system for movable objects and an information processing method for movable objects.

### BACKGROUND OF THE INVENTION

JP2019-189032A discloses a following invention of a vehicle running system of vehicles running in a row, each of which is equipped with a vehicle control system. This vehicle control system comprises a forward area watching sensor and a control device to control running of a driver's vehicle. The control device is configured to adjust a gap between the driver's vehicle and an immediately ahead-positioned vehicle in the row in accordance with a running state of another vehicle that is trying to run into the gap when the driver's vehicle detects this vehicle to change lanes into the gap with sensors. For instance, the driver's vehicle may inhibit another vehicle from coming into the row of the vehicles by making the gap to the immediately ahead-positioned vehicle shorter. On the other hand, the driver's vehicle can allow another vehicle to safely change lanes into the row by making the gap to the immediately ahead-positioned vehicle longer in the row of the vehicles.

When a driver's vehicle is running straight to pass through an intersection, there can be a circumstance in which vehicles are at a stop in a row in a road section just ahead of the intersection with no space in the road section left for the driver's vehicle to come into.

If the driver's vehicle runs into the intersection in this circumstance described above, the driver's vehicle is unable to run into the road section ahead of the intersection and could be at a stop in the intersection and disrupt other vehicles running.

However, even in the circumstance as described above, there is likely a possibility for the vehicles being at a stop in a row on the road section ahead of the intersection to be able to make a space on the road section for the driver's vehicle to run into by shortening gaps between each two vehicles next to each other.

### SUMMARY OF THE INVENTION

Taking the above mentioned into consideration, an objective of the present invention is to enable a movable object to smoothly pass through a movable object stopping prohibited area to move into a road section that is ahead of the movable object stopping prohibited area and jammed with other movable objects being at a stop in a row and stop rearward of the row of the other movable objects.

There is another circumstance in which a row of plural vehicles is at a stop on a first road and disrupts a driver's vehicle running into an intersection of the first road and a second road on which the driver's vehicle is running, the second road overlapping the first road at the intersection that may be a crossroad or a T-junction, when the driver's vehicle is attempting to run into the intersection.

In the circumstance like this, the driver's vehicle has to be at a stop and wait for the other vehicles to move on the first road to make a space for the driver's vehicle to run through.

However, there is likely a possibility that a space is made for the driver's vehicle to run through if the other vehicles on the second road shorten gap distances between them.

Taking the above mentioned into consideration, another objective of the present invention is to enable a driver's vehicle running on the second road to smoothly run into the intersection of the second road and the first road on which a row of other vehicles is at a stop, the second road connected to the first road at the intersection that may be a T-junction or a crossroad, when the driver's vehicle is attempting to run into the intersection.

The present invention has a feature of including a processor comprising an information receiving section receiving information on a distance L_{d} from a rear end of a most rearward first movable object located most rearward in a row of plural first movable objects on a road to a movable object stopping prohibited area and a length l_{V} of a second movable object that is stopping or scheduled to stop behind the most rearward first movable object, a first determining section determining whether the distance L_{d} and the length l_{V} that are received by the information receiving section meet a condition of “L_{d}<l_{V}” and a signal sending section sending the plural first movable objects forming the row on the road a signal including a first instruction to instruct the plural first movable objects to shorten a gap distance between the first movable objects next to each other to a first distance, if the first determining section determines that the condition of “L_{d}<l_{V}” is met.

The present invention has another feature of including a processor comprising;

an information receiving section receiving information on a distance L between two movable object stopping prohibited areas between which there is a row of plural first movable objects at a stop on a first road, a length l_{VX} of each of the plural first movable objects and a width l_{W} of a second movable object running on a second road that is attempting to run into the first road crossing the second road;

a first determining section determining whether the distance L, the lengths l_{VX} and the width l_{w} that are received by the information receiving section meet a condition of “L>Σl_{VX}+l_{W}” and

a signal sending section sending the plural first movable objects a first signal including a first instruction to instruct the plural first movable objects to shorten a gap distance between movable objects next to each other to a first distance to make a gap wider than the width l_{W} in an entering area to the first road so that the second movable object is able to run through the gap into the first road, if the first determining section determines that the condition of “L>Σl_{VX}+l_{W}” is met.

The present invention enables a movable object that is a driver's vehicle to smoothly pass through a movable object stopping prohibited area and stop behind a row of other movable objects on a road section ahead of the movable object stopping prohibited area even if the road section ahead of the movable object stopping prohibited area is jammed with the other movable objects in a row.

Furthermore, the present invention enables the driver's vehicle that is running on a road to enter an intersection such as a T-junction or a crossroad to smoothly run to enter the intersection even if other vehicles are at a stop in a row on a different road that runs across the intersection.

### BRIEF DESCRIPTION OF THE DRAWINGS

FIG. 1 is a whole configuration of a vehicle equipped with an information processing system for movable objects according to an embodiment of the present invention.

FIG. 2 is a functional block diagram for a vehicle control apparatus according to the embodiment and other connected devices therewith.

FIG. 3 shows schematically a configuration of HMI for a vehicle of the embodiment.

FIG. 4 shows a front portion of a vehicle of the embodiment.

FIG. 5 is a functional block diagram illustrating how an information processing system for movable objects of the embodiment operates.

FIG. 6 is a flow chart of processes performed by the information processing system for movable objects of a first embodiment of the present invention when the vehicle is a second movable object.

FIG. 7 shows a plan view of roads including their intersection illustrating the processes performed by the information processing system for movable objects of the first embodiment.

FIG. 8 shows a data configuration of inquiries to be sent by the information processing system for movable objects of the embodiment.

FIG. 9 shows a plan view of roads including their intersection illustrating the processes performed by the information processing system for movable objects of the first embodiment.

FIG. 10 is a flow chart of processes performed by the information processing system for movable objects of a second embodiment of the present invention when the vehicle is a second movable object.

FIG. 11 shows a plan view of roads including their intersection for illustrating the processes performed by the information processing system for movable objects of the second embodiment.

FIG. 12 shows a plan view of roads including their intersection illustrating the processes performed by the information processing system for movable objects of the second embodiment.

### DETAILED DESCRIPTION OF EMBODIMENT

Hereinafter, an information processing system for movable objects according to the present invention is described with reference to the attached figures.

A common sign is assigned to plural members having a common function in the attached figures. In addition, some members are schematically drawn to have sizes and shapes that are modified or exaggerated for the convenience of explanation.

When left and right directions of a vehicle 1 are referred to in the description of the information processing system for movable objects of the embodiment of the present invention below, the left and right directions are directions for a person facing frontward of the vehicle. To be specific, a driver's seat side corresponds to a right side while a passenger seat side corresponds to a left side, if the vehicle 1 is a right-hand drive vehicle. In principle, a first movable object 1A and a second movable object 1B have the same configuration as the vehicle 1. The first movable object 1A may have a different configuration from the vehicle 1, which is explained later.

The vehicle 1 is a vehicle that is capable of being autonomously driven at an autonomous driving level equal to or higher than Level 4 defined by SAE (Society of Automotive Engineers) International.

<Configuration of Vehicle 1>

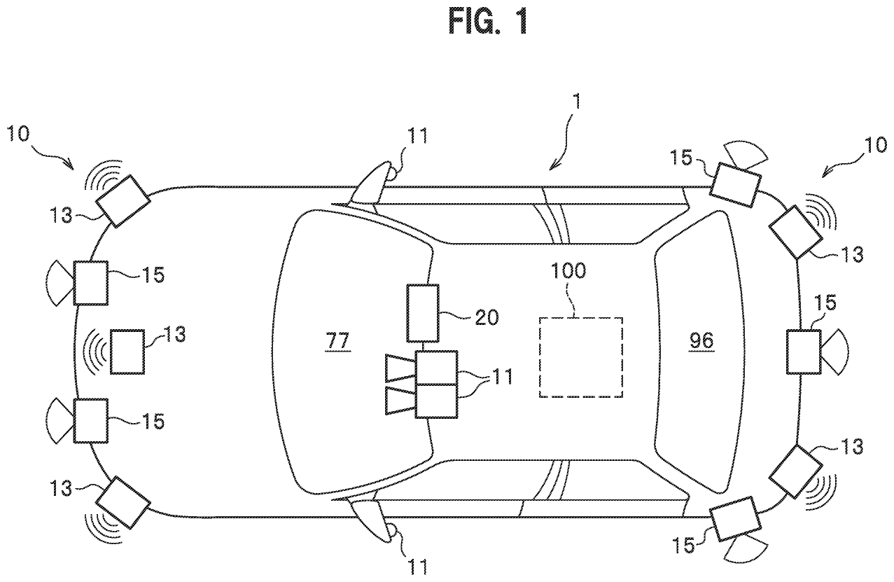

To begin with, a configuration of the vehicle 1 equipped with an information processing system for movable objects of the embodiment of the present invention is described with reference to FIG. 1.

FIG. 1 shows a whole configuration of a vehicle equipped with an information processing system for movable objects of the embodiment of the present invention.

The vehicle 1 equipped with the information processing system for movable objects of the embodiment may be a vehicle such as a two-wheel vehicle, three-wheel vehicle or a four-wheel vehicle.

The vehicle 1 may be an automotive vehicle having an internal combustion engine such as a diesel engine or a gasoline engine as a power source, an electric vehicle having an electrical motor as a power source, or a hybrid vehicle having both the internal combustion engine and the electrical motor. The electric vehicle is driven by electric power discharged by a battery such as a secondary battery, a hydrogen fuel cell, a metal fuel cell or an alcohol fuel cell.

As shown in FIG. 1, the vehicle 1 includes external world sensors 10 having a function to detect external world information on indicative objects inclusive of an object and a road sign around the vehicle 1, a navigation device 20 having a function to map a current position of the vehicle 1 to a map and indicate a route to a destination and a vehicle control apparatus 100 having a function to perform autonomous running control of the vehicle 1 including steering, accelerating and decelerating the vehicle 1.

These devices are connected with one another through a communication medium such as CAN (Controller Area Network) so that they can communicate with one another.

<External World Sensor 10>

The external world sensors 10 includes cameras 11, radars 13 and LiDARs 15.

The camera 11 has an optical axis extending frontward of the driver's vehicle inclining diagonally downward and is capable of taking an image of an area frontward of the vehicle 1. The camera 11 may be a CMOS (Complementary Metal Oxide Semiconductor) camera, or a CCD (Charge Coupled Device) camera. The cameras 11 may be installed in the vicinity of a rearview mirror (not shown) inside a vehicle compartment of the vehicle 1, on an outer side of a front portion of a right-side door of the vehicle 1, on an outer side of a front portion of a left-side door of the vehicle 1 and on other portions of the vehicle 1.

The cameras 11 repeatedly and periodically take images of, for instance, an area frontward of the vehicle 1, an area rearward of and on the right side of the vehicle 1 and an area rearward of and on the left side of the vehicle 1. There is a pair of the cameras 11 which may be monocular cameras aligned horizontally and installed in the vicinity of the rearview mirror in the embodiment. The cameras 11 may be stereo cameras.

Image information taken by the cameras 11 on the area frontward of the vehicle 1, the area rearward of and on the right side of the vehicle 1 and the area rearward of and on the left side of the vehicle 1 is sent to the vehicle control apparatus 100 through the communication medium.

The radars 13 have a function to emit radar waves toward indicative objects inclusive of an ahead-positioned vehicle which is running just ahead of the vehicle 1 and the vehicle 1 is to follow, receive the radar wave that reflects from the indicative objects and obtain distribution information on the indicative objects inclusive of a distance to each of the indicative objects and a direction in each of which the indicative objects is present. A laser, a microwave, a millimeter wave and an ultrasonic wave may be appropriately used for the radar wave.

As shown in FIG. 1, there are five radars 13 attached to the vehicle 1 in the embodiment, three of them are attached on the front side of the vehicle 1 and two of them are on the rear side of the vehicle 1. The distribution information on the indicative objects obtained by the radars 13 are sent to the vehicle control apparatus 100 through the communication medium.

The LiDARs 15 (LiDAR: Light Detection and Ranging) have a function to measure a time from when a radiation light is emitted toward an indicative object to when a scattered light from the indicative object is received and detect whether there is an indicative object and a distance to the indicative object. As shown in FIG. 1, there are five LiDARs 15 attached to the vehicle 1 in the embodiment, two of them are attached to the front side of the vehicle 1 and three of them are attached to the rear side of the vehicle 1. The distribution information on the indicative objects obtained by the LiDARs 15 is sent to the vehicle control apparatus 100 through the communication medium.

<Navigation Device 20>

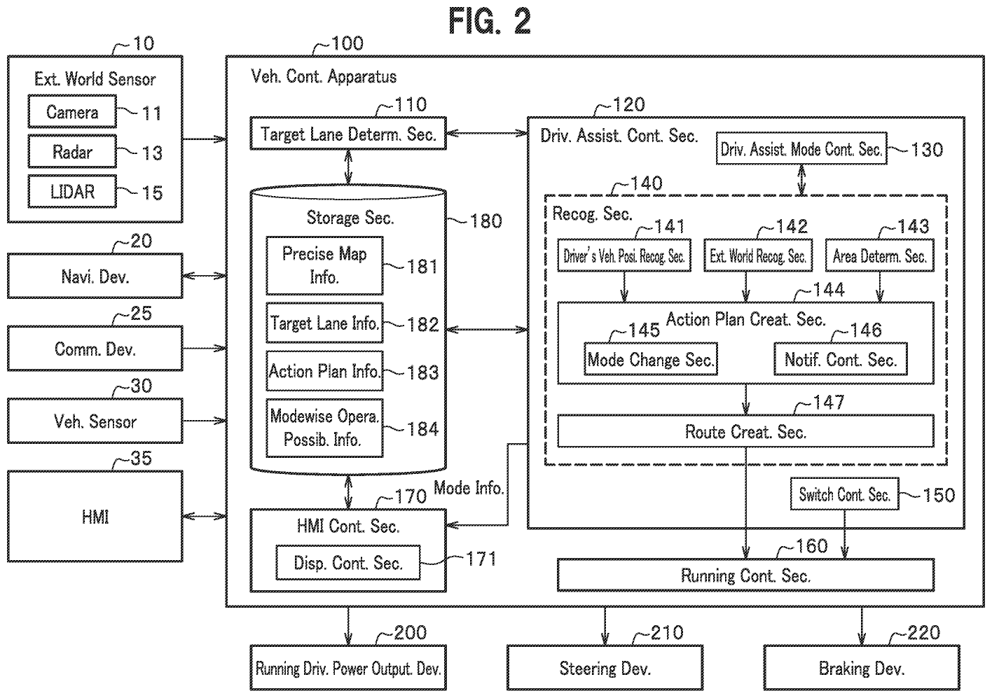

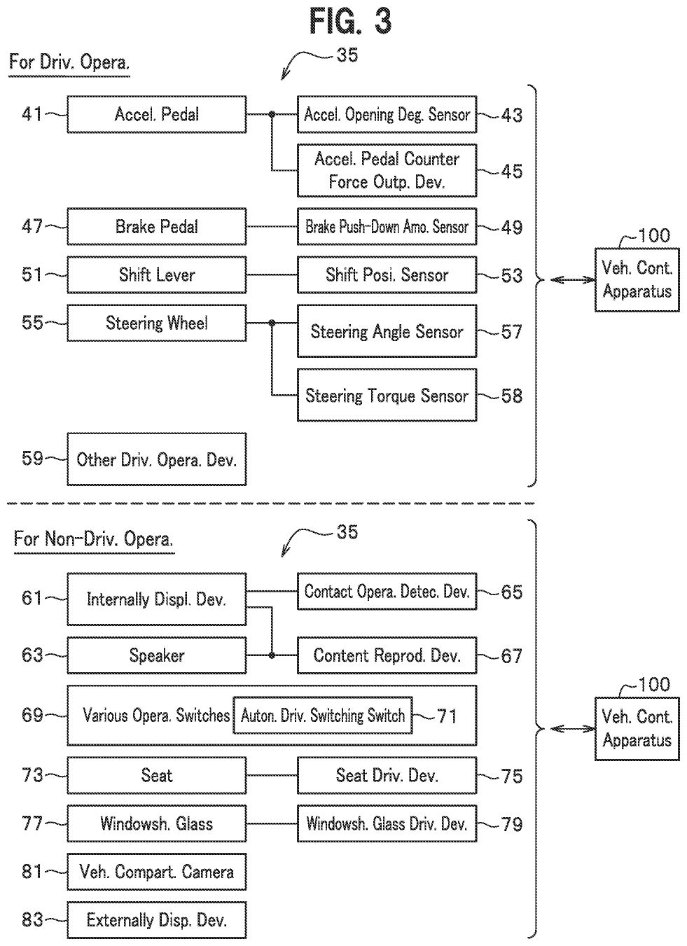

The navigation device 20 (See FIG. 2) comprises a GNSS (Global Navigation Satellite System) receiver, map information (navigation map), an internally displaying device (See FIG. 3) 61 that is a touch panel type display to function as a human-machine interface, a speaker 63 (See FIG. 3), and a microphone. The navigation device 20 has a function of determining a current position of the vehicle 1 with the GNSS receiver and calculating a route from the current position to a destination designated by a user.

The route calculated by navigation device 20 is provided to a target lane determination section 110 (described later) of the vehicle control apparatus 100. The current position of the vehicle 1 may be identified or supplementally checked by an INS (Inertial Navigation System) that makes use of an output of a vehicle sensor 30. In addition, the navigation device 20 may provide guides on the route to the destination with voices or indications on the map.

Alternatively, the function to determine the current position of the vehicle 1 is provided independently from the navigation device 20. In addition, the navigation device 20 is realized by a function of, for example, such a terminal device as a smartphone or a tablet. In this case, information is communicated between the terminal device and the vehicle control apparatus 100 wirelessly or by wire.

<Vehicle Control Device 100 and Other Connected Devices Therewith>

Next, the vehicle control apparatus 100 and other connected devices therewith, which are attached to the vehicle 1, are described with reference to FIG. 2.

FIG. 2 shows a functional block diagram of the vehicle control apparatus 100 and other connected devices therewith.

The vehicle 1 includes the vehicle control apparatus 100, a vehicle sensor 30, an HMI (Human Machine Interface) 35, a running driving power outputting device 200, a steering device 210 and a braking device 220, in addition to the external world sensors 10 and the navigation deice 20 both of which have been described.

A communication device 25, the vehicle sensor 30, the HMI 135, the driving power outputting device 200, the steering device 210 and the braking device 220 are connected with the vehicle control apparatus 100 and are able to mutually communicate data with the vehicle control apparatus 100 through a communication medium.

<Communication Device 25>

The communication device 25 has a function to communicate through such a wireless communication medium as a cellular network, a Wi-fi network, Bluetooth (Registered trademark) or DSRC (Dedicated Short-Range Communication).

The communication device 25 performs wireless communication, for example, with an information providing server that monitors a traffic state of a road and receives traffic information on the traffic state of a road along which the vehicle 1 is running now or scheduled to run. The traffic information includes information on traffic jam, information on a time needed to pass through a congested road section, information on an accident, a disabled vehicle and a road construction, information on a speed limit and a lane restriction, information on a position of a parking place, and information on whether a parking place, a service area and a parking area are fully occupied or not.

The communication device 25 may receive the information as above mentioned by wirelessly communicating with a beacon installed at a road shoulder or other vehicles running near the vehicle 1.

In addition, the communication device 25 wirelessly communicates, for example, with an information providing server of TSPS (Traffic, Signal Prediction Systems) to receive traffic light information for traffic lights installed along a road along which the vehicle 1 is running or scheduled to run.

TSPS performs a function to support a vehicle running smoothly to pass through an intersection with a traffic light making use of the traffic light information.

The communication 25 may communicate with an optical beacon installed at a road shoulder or perform vehicle-to-vehicle communication with other vehicles running near the vehicle 1 to receive the traffic information above mentioned (vehicle-to-vehicle communication is described later).

<Vehicle Sensor 30>

The vehicle sensors 30 has a function to detect various pieces of information on the vehicle 1. The vehicle sensors 30 includes a vehicle speed sensor to measure a vehicle speed of the vehicle 1, an acceleration sensor to measure an acceleration on the vehicle 1, a yaw rate sensor to measure an angle velocity about a vertical axis of the vehicle 1, a direction sensor to measure an orientation of the vehicle 1, an inclination angle sensor to measure an inclination angle of the vehicle 1, a brightness sensor to measure a brightness of a place where the vehicle 1 is present, and a raindrop sensor to measure an amount of raindrops in a place where the vehicle 1 is present.

<Configuration of HMI 35>

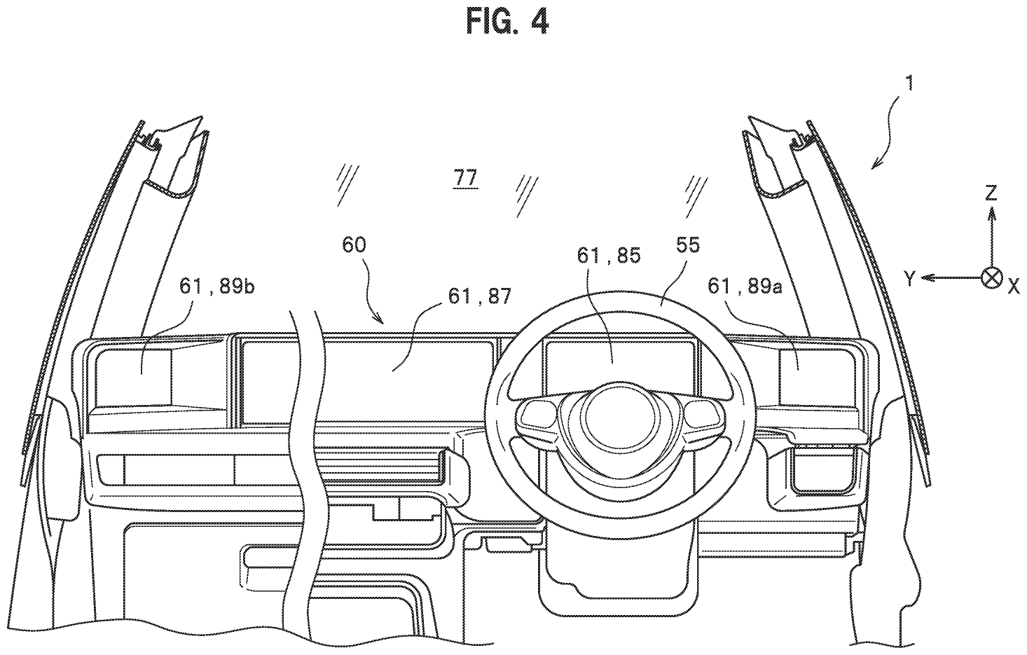

Next, the HMI 35 is described with reference to FIG. 3 and FIG. 4.

FIG. 3 shows schematically a configuration of the HMI 35. FIG. 4 shows a front structure of a vehicle compartment of the vehicle 1 equipped with the vehicle control apparatus 100.

The HMI 35 includes a group of components for a driving operation and a group of other components for operations other than the driving operation. However, the distinction between these groups is not clear and a component for the driving operation may have a function for the operation other than the driving operation as well (or vice versa).

As shown in FIG. 3, the HMI 35 includes an accelerator pedal 41, an accelerator opening rate sensor 43, an accelerator counter force outputting device 45, a brake pedal 47, a brake pedal push-down amount sensor 49, a shift lever 51, a shift position sensor 53, a steering wheel 55, a steering angle sensor 57, a steering torque sensor 58, and another driving operation device 59.

The accelerator pedal 41 is an accelerating operation component to receive an accelerating instruction (or a decelerating instruction by a release-back operation) operation from a driver. The accelerator opening rate sensor 43 detects an amount of the accelerator pedal 41 being pushed down and outputs an accelerator opening rate signal indicating the amount to the vehicle control apparatus 100.

The accelerator opening rate signal may be output directly to the driving power output device 200, the steering device 210 and the braking device 220, instead of being output to the vehicle control apparatus 100. This is the case with the following components for the driving operation to be described below. The accelerator pedal counter force outputting device 45 outputs a force (counter force against operation) to the accelerator pedal 41 that is determined according to an instruction from the vehicle control apparatus 100 and acts in an opposite direction to an accelerator pedal effort.

The braking pedal 47 is a decelerating operation component to receive a decelerating instruction from a driver. The brake pedal push-down amount sensor 49 detects an amount of the brake pedal 47 being pushed down (or brake pedal effort) and outputs a brake signal indicating a detected result to the vehicle control apparatus 100.

The shift lever 51 is a shift operation component to receive a change instruction to change the shift position from a driver. The shift position sensor 53 detects the shift position instructed by a driver and outputs a shift position signal indicating a detected result to the vehicle control apparatus 100.

The steering wheel 55 is a steering operation component to receive a turning instruction by a driver. The steering angle sensor 57 detects a steering angle of the steering wheel 55 and outputs a steering angle signal indicating a detected result to the vehicle control apparatus 100. The steering torque sensor 58 detects a torque applied to the steering wheel 55 and outputs a steering torque signal indicating a detected result to the vehicle control apparatus 100.

The driving operation device 59 may be a joystick, a button, a dial switch or a GUI (Graphical User Interface) switch. The driving operation device 59 receives such instructions as an accelerating instruction, a decelerating instruction and a turning instruction and outputs them to the vehicle control apparatus 100.

As shown in FIG. 3, the HMI 35 includes components for the operation other than the driving operation such as an internally displaying device 61, a speaker 63, a contact operation detecting device 65, a content playback device 67, various operation switches 69, a seat 73, a seat driving device 75, a windshield glass 77, a windshield glass driving device 79, a vehicle compartment camera 81 and an externally displaying device 83

The internally displaying device 61 has a function to display various pieces of information for passengers in the vehicle compartment and is preferably a touch-panel type display device. As shown in FIG. 4, the internally displaying device 61 includes several panels of an instrument panel 60 as follows. One is a meter panel 85 installed to be opposite to a driver seat. One is a multi-information panel 87 that is in an elongated shape in the vehicle width direction and disposed opposite to both the driver seat and a passenger seat. One is a right-side panel 89a disposed on a driver side in the vehicle width direction. The other is a left-side panel 89b disposed on a passenger side in the vehicle width direction. The internally displaying device 61 may be additionally installed at a position opposite a rear seat (on a rear side of a front seat).

The meter panel 85 displays, for example, a speed meter, a tachometer, an odometer, the shift position information and information on whether each illumination lamp is turned on.

The multi-information panel 87 displays various pieces of information such as map information on an area around the vehicle 1, current position information on a current position of the vehicle 1 on a map, traffic information on a road along which the vehicle 1 is running now and scheduled to run (inclusive of traffic light information), traffic participant information on traffic participants present around the vehicle 1 (inclusive of a pedestrian, a bicycle, a motor bike and other vehicles) and a message to be notified to the traffic participants.

The right-side panel 89a displays image information taken by a camera 11 attached on the right side of the vehicle 1 of an area on the right side of the vehicle 1 and rearward and downward of the vehicle 1.

The left-side panel 89b displays image information taken by a camera 11 attached on the left side of the vehicle 1 of an area on the left side of the vehicle 1 and rearward and downward of the vehicle 1.

The internally displaying device 61 is not limited to a specific device and may be an LCD (Liquid Crystal Display) or an Organic EL (Electroluminescence) display. The internally displaying device 61 may be a HUD (Head Up Display) that projects an image on the windshield glass 77.

The speaker 63 has a function to output a voice. There should be as many speakers 63 in the vehicle compartment as are needed to install at such appropriate parts as the instrument panel 60, a door panel (not shown) and a rear parcel shelf (not shown).

The contact operation detecting device 65 has a function to detect a touched position on a display surface of the internally displaying device 61 and output information on the touched position to a vehicle control apparatus 100, when the internally displaying device 61 is of a touch panel type. If the internally displaying device is not of a touch panel type, the contact operation detecting device 65 may be skipped.

The content playback device 67 may be a DVD (Digital Versatile Disc) playback device, a CD (Compact Disc) playback device, a television receiver and a playback device for various guide images. All or part of the internally displaying device 61, the speaker 63, the contact operation detecting device 65 and the content playback device 67 may be devices that are used for the navigation device 20 as well.

The various operation switches 69 are installed at appropriate positions in the vehicle compartment. The various operation switches 69 include an autonomous driving switching switch 71 to immediately start (or start in near future) or stop autonomous driving. The autonomous driving switching switch 71 may be any of a GUI (Graphical User Interface) switch and a mechanical switch. In addition, the various operation switches 69 may include switches to drive a seat driving device 75 and a windshield glass driving device 79.

The seat 73 is a seat on which a passenger of the vehicle 1 sits. The seat driving device 75 drives the seat 73 to adjust a reclining angle, a front-rear direction position and a yaw angle of the seat 73. The windshield glass 77 is installed on every door. The windshield glass driving device 79 drives the windshield glass 77 to open and close.

The vehicle compartment camera 81 may be a digital camera with a solid imaging device such as CCD or CMOS. The vehicle compartment camera 81 may be disposed at such a position that an image of at least a head portion of a driver can be taken, for example, at the rearview mirror (not shown), a steering boss portion (not shown), or the instrument panel 60. The vehicle compartment camera 81 may, for instance, repeatedly and periodically take an image of the inside of the vehicle compartment including a driver.

The externally displaying device 83 has a function to display various pieces of information to traffic participants (including a pedestrian, a bicycle, a motor bike and other vehicles) that are present around the vehicle 1. The externally displaying device 83 includes a right-front lighting portion and a left-front lighting portion (not shown) which are disposed on both sides in the vehicle width direction of a front grille of the vehicle 1. In addition, the externally displaying device 83 further includes a right-rear lighting portion and a left-rear lighting portion (not shown) which are disposed on both sides in the vehicle width direction of a rear grille of the vehicle 1.

These lighting portions include a headlamp, a position lamp and a turn signal lamp and the like.

<Configuration of Vehicle Control Apparatus 100>

Next, a configuration of the vehicle control apparatus 100 is described with reference to FIG. 2.

The vehicle control apparatus 100 needs to include, for example, one or more processors or other hardware devices having an equivalent capability to perform its functions. The vehicle control apparatus 100 may be ECU (Electronic Control Unit) including a processor such as CPU (Central Processing Unit), a storage device and a communication interface, which are connected through internal bus lines, or a combination of MPU (Micro-Processing Unit) and other devices.

The vehicle control apparatus 100 includes a target lane determining section 110, a driving assistance control section 120, a running control section 160, an HMI control section 170 and a storage section 180.

A function of the target lane determining section 110, a function of each section of the driving assistance control section 120 and a part or a whole of a function of the running control section 160 may be performed by the processor executing a program (software). In addition, part or all of these functions may be performed by a hardware device such as LSI (Large Scale Integration) or ASIC (Application Specific Integrated Circuit) or by a combination of software and hardware.

Hereinafter, when “xxx section” is referred to as a subject, the driving assistance control section 120 reads each program from ROM or EPROM (Electrically Erasable Programmable Read-Only Memory) and loads it to RAM to have each function (to be described later) performed. Each program may be stored in the storage section 180 in advance or may be sent through another storage medium or communication medium to the vehicle control apparatus 100 and loaded there when needed.

<Target Lane Determining Section 110>

For example, MPU (Micro Processing Unit) may perform functions of the target lane determining section 110. The target lane determining section 110 divides the route provided by the navigation device 20 into plural route sections (for instance, each route section is 100 m long in the vehicle running direction) and determines a target lane for each of the route sections with reference to precise map information 181. The target lane determining section 110 determines, for example, which one of the lanes numbered from the left-most lane in each route section the vehicle 1 should run on. For instance, if there is a junction ahead where a current road along which the vehicle 1 is running branches into two roads or another road joins the current road, the target lane determining section 110 determines a reasonable target lane so that the vehicle 1 can run through the junction to run on an intended road after passing the junction. The target lane determined by the target lane determining section 110 is stored as target lane information 182 in the storage section 180.

<Driving Assistance Control Section 120>

The driving assistance control section 120 may comprise a driving assistance state control section 130, a recognizing section 140 and a switch control section 150.

<Driving Assistance Mode Control Section 130>

The driving assistance state control section 130 may be configured to determine an autonomous driving mode (autonomous driving assistance state) that the driving assistance control section 120 performs based on an operation the driver performs on the HMI 35, an event that an action plan creating section 144 determines, a running mode determined by a route creating section 147, and the like. The autonomous driving mode is notified to the HMI control section 170.

No matter what autonomous driving mode the vehicle 1 is in, it can be switched to (overridden by) a lower-level autonomous driving mode by performing an operation on a component of the HMI 35 for the driving operation.

This overriding occurs, if an operation performed by the driver on the vehicle 1 on the component of the HMI 35 for the driving operation continues over a longer time than a predetermined time, if the operation gives rise to an operation amount larger than a predetermined operation change amount (for example, the acceleration opening degree of the acceleration pedal 41, the pushing-down amount of the brake pedal 47 and the steering angle of the steering wheel 55), or if the operation on the component for driving operation is performed more times than predetermined times.

<Recognizing Section 140>

The recognizing section 140 may comprise a driver's vehicle position recognizing section 141, an external world recognizing section 142, an area determining section 143, an action plan creating section 144 and a route creating section 147.

<Driver's Vehicle Position Recognizing Section 141>

The driver's vehicle position recognizing section 141 may be configured to recognize a running lane on which the vehicle 1 is running and a relative position of the vehicle 1 in the running lane based on the precise map information 181 stored in the storage section 180 and information input from the camera 11, the radar 13, the LiDAR 15, the navigation device 20 and the vehicle sensors 30.

The driver's vehicle position recognizing section 141 recognizes the running lane of the vehicle 1 by comparing a pattern of road partitioning lines recognized based on the precise map information 181 (for example, how solid lines and dashed lines are arranged) with a pattern of road partitioning lines around the vehicle 1 that are recognized based on images taken by camera 11. When recognizing the running lane of the vehicle 1, the current position of the vehicle 1 received from the navigation device 20 or a processed result by INS may be taken into consideration.

<External World Recognizing Section 142>

The external world recognizing section 142 may be configured to recognize a state of the external world including positions, vehicle speeds and accelerations of nearby vehicles based on external world information input from the external world sensor 10 including the camera 11, the radar 13 and the LiDAR 15, as shown in FIG. 2. Here, the nearby vehicle is, for example, a vehicle that is running around the vehicle 1 and in the same direction as the vehicle 1.

The position of the nearby vehicle may be represented by such an exemplary point as a center of mass or a corner or by a region described by a profile of the nearby vehicle. The state of the nearby vehicle may include the acceleration of the nearby vehicle and whether the nearby vehicle is changing lanes (or trying to change running lanes) that are recognized based on information from the devices as above mentioned. Furthermore, the external world recognizing section 142 may be configured to recognize positions of the indicative objects inclusive of a guard rail, a utility pole, a parking vehicle, a pedestrian, and a traffic sign in addition to the nearby vehicles.

In the embodiment of the present invention, a vehicle, which is one of the nearby vehicles that is running just ahead of the vehicle 1 and is an object for the vehicle 1 to follow under the follow-up running control, is referred to as an “ahead-located vehicle”.

<Area Determining Section 143>

The area determining section 143 is configured to recognize a special area (IC/JCT/Lane increasing/Lane decreasing point) in an area located ahead of the vehicle 1. The area determining section 143 may recognize the special area from the map information. Even when the vehicle 1 cannot take an image of an area ahead of the vehicle 1 with the external world sensor 10 because of an ahead-located vehicle being in the way, the area determining section 143 can obtain information on the area to help the vehicle 1 run smoothly ahead.

The area determining section 143 may receive information on the special area by identifying an indicative object ahead based on image processing on an image of an area ahead taken by the external world sensor 10 or by recognizing an indicative object ahead based on a profile of the indicative object recognized in an image of the special area ahead taken by the external world sensor 10 after internal processing by the external world recognizing section 142 on the image, instead of determining the special area based on the map information.

In addition, as described later, the information on the special area obtained by the area determining section 143 may be checked by making use of VICS information received by the communication device 25 to increase a precision of the information on the special area obtained by the area determining section 143.

<Action Plan Creating Section 144>

The action plan creating section 144 is configured to set a start point of the autonomous driving and/or a destination of the autonomous driving. The start point of the autonomous driving may be a current position or a position at which the operation for the autonomous driving is performed. The action plan creating section 144 is configured to create an action plan for the route sections between the start point and the destination of the autonomous driving. In addition, the action plan creating section 144 may create an action plan for any route section as well.

The action plan is constituted by, for instance, various events that are to be performed in a sequential order. The various events include, for example, a deceleration event to decelerate the vehicle 1, an acceleration event to accelerate the vehicle 1, a lane keeping event to have the vehicle 1 keep on running in a running lane without deviating from the running lane, a lane change event to change running lanes, an overtaking event to have the vehicle 1 overtake an ahead-located vehicle running ahead of the vehicle 1, a branching point event to have the vehicle 1 change running lanes to a lane the driver wants to take or keep on running on the current lane without deviating from the current lane when the vehicle 1 passes through the branching point, a joining point event to have the vehicle 1 accelerate or decelerate to change running lanes to join a main running lane from a joining lane, a hand-over event to switch from the manual driving mode to the autonomous driving mode (autonomous driving assistance state) at a start point of the autonomous driving or switch from the autonomous driving mode to the manual driving mode at an end point at which the autonomous driving is scheduled to end.

The action plan creating section 144 schedules the lane change event, the branching point event or the joining point event at a position where the target lane that the target lane determining section 110 determines is changed to another lane. Information on the action plan created by the action plan creating section 144 is stored in the storage section 180 as action plan information 183.

The action plan creating section 144 comprises a mode switch section 145 and a notification control section 146.

<Mode Switch Section 145>

The mode switch section 145 may be configured to select a driving mode from among plural predefined phases of autonomous driving mode and the manual driving mode based on a recognized result of an indicative object that is present in a direction in which the vehicle 1 is running, the driving mode being fit for the recognized result, and have the vehicle 1 perform a driving operation in the selected driving mode.

<Notification Control Section 146>

When the driving mode of the vehicle 1 is transitioned by the mode switch section 145, a notification control section 146 notifies a driver on the vehicle 1 that the driving mode has transitioned. The notification control section 146 notifies the transition of the vehicle 1, for example, by having the speaker 63 output a piece of voice information that is stored in the storage section 180 in advance.

The notification to the driver is not necessarily performed with this voice message, which is just an example. As long as it is possible to notify the driver on the vehicle 1 of the transition of the driving assistance state, this notification may be performed with other means than voice, such as light emission, indication on a display, vibration, or a combination of these.

<Route Creating Section 147>

The route creating section 147 may be configured to create a route for the vehicle 1 to run along based on the action plan created by the action plan creating section 144.

<Switch Control Section 150>

A switch control section 150 may be configured to switch between the manual driving mode and the autonomous driving mode, based on a signal input from the autonomous driving switching switch 71 (See FIG. 3) or the like, as shown in FIG. 2. In addition, the switch control section 150 may switch the current autonomous driving mode to a lower-level driving mode based on an operation on a component of the HMI 35 for the driving operation for acceleration, deceleration, or steering. For instance, the switch control section 150 may switch the current autonomous driving mode to a lower-level driving mode (overriding) when a state in which an operation amount indicated by a signal input from the component of HMI 35 for driving operation is over a threshold amount continues for a longer time than a predetermined time.

The switch control section 150 may switch the autonomous driving mode back to the previous autonomous driving mode if no operation on the component of HMI 35 for the driving operation is detected over a predetermined time after the autonomous driving mode is switched to a lower-level driving mode.

<Running Control Section 160>

A running control section 160 may be configured to control the running driving power output device 200, the steering device 210 and the braking device 220 in such a way that the vehicle 1 runs through the route that the route creating section 147 has created on time as scheduled, in order to perform running control of the vehicle 1.

<HMI Control Section 170>

An HMI control section 170 may be configured to control HMI 35 in accordance with mode dependent allowable operation information 184 (See FIG. 2) the autonomous driving mode currently set when receiving information on the autonomous driving mode from the driving assistance control section 120. The mode dependent allowable operation information 184 is a piece of information indicating for each driving mode which devices are allowed to be used (navigation device 20 and part or a whole of the HMI 35) and which devices are not allowed to be used.

As shown in FIG. 2, the HMI control section 170 may determine those devices that are allowed to be used (navigation device 50 and part or all of HMI 35) and those devices that are not allowed to be used with reference to the mode dependent allowable operation information 184 based on the information on the autonomous driving mode received from the driving assistance control section 120.

In addition, the HMI control section 170 may determine whether an operation by the driver on a component of the HMI 35 for the driving operation or on the navigation device 20 should be enabled or not, based on the determination result.

For instance, when the vehicle control apparatus 100 is performing the manual driving mode, the operate by the driver components of HMI 35 for the driving operation (for example, accelerator pedal 41, brake pedal 47, shift lever 51 and steering wheel 55, See FIG. 3) is enabled.

The HMI control section 170 includes a display control section 171.

<Display Control Section 171>

The display control section 171 performs display control on an internally displaying device 61 and an externally displaying device 83. Specifically, for instance, the display control section 171 has the internally displaying device 61 and/or the externally displaying device 83 display information of a reminder, a warning or a driving assistance to the traffic participants present near the vehicle 1, when the driving mode being performed by the vehicle control apparatus 100 is an autonomous driving mode of a high autonomous driving level. This is detailed later.

<Storage Section 180>

The storage section 180 may store, for example, precise map information 181, target lane information 182, action plan information 183, mode dependent allowable operation information 184 and the like. The storage section 180 may be ROM (Read Only Memory), RAM (Random Access Memory, HDD (Hard Disk Drive), a flash memory, or the like. A program to be executed by a processor may be stored in the storage section 180 in advance or downloaded from an external device through an internet device mounted on the driver's vehicle. Alternatively, the program is stored in a portable storage medium and installed into the storage section 180 when the portable storage medium is connected with a drive device (not shown).

The precise map information 181 may provide more precise map information than navigation map information installed in the navigation device 20. The precise map information 181 may include, for example, information on a center portion of a lane and a boundary of the lane. The boundary of the lane includes a kind, a color and a length of a lane mark, a width of a lane, a road width, a width of a road shoulder, a width of a main lane, a width of a running lane, a position of the boundary, a kind of the boundary (guard rail, softscape, kerbstone), a zebra pattern zone for guiding and the like, and these boundaries are included in the precise map.

In addition, the precise map information 181 may include road information, traffic restriction information, address information (address/post code), facility information and telephone number information. The road information includes information representing a kind of a road such as an expressway, a toll road, a national road and a prefectural road, a number of lanes, a width of each lane, a slope of a road, a position of a road (three dimensional coordinates including a longitude, a latitude and an altitude), a curvature of a curve of a road, a position of a junction of or a branching point to lanes, a road sign installed along a road and the like. The traffic restriction information includes information on a road being blocked by a construction, a traffic accident, a traffic jam, or the like.

[Running Driving Power Generating Apparatus 200, Steering Device 210, Braking Device 220]

The vehicle control apparatus 100 may be configured to control the running driving power generating apparatus 200, the steering device 210 and the braking device 220 in accordance with a running control instruction from the running control section 160, as shown in FIG. 2.

<Running Driving Power Generating Apparatus 200>

The running driving Power output device 200 is configured to output a running driving force (torque) to drive wheels. The running driving power output device 200 may include, for example, an internal combustion engine, a transmission and an engine ECU (Electronic Control Unit, not shown) to control the internal combustion engine, if the driver's vehicle M is an automotive vehicle having a driving force source of an internal combustion engine.

Alternatively, the running driving power output device 200 may include a driving motor (not shown) and a motor ECU to control the motor (not shown), if the driver's vehicle M is an electric vehicle having a driving force source of an electric motor.

Alternatively, the running driving power output device 200 may include an internal combustion engine, a transmission, an engine ECU, a driving motor and a motor ECU (all of these are not shown), if the driver's vehicle M is a hybrid vehicle.

If the running driving power output device 200 includes only the internal combustion engine, the engine ECU is configured to control a throttle opening rate of the internal combustion engine, a shift level and the like in accordance with information received from the running control section 160 described later. If the running driving power output device 200 includes only the driving motor, the motor ECU is configured to control a duty ratio of a PWM signal to be applied to the driving motor in accordance with the information received from the running control section 160.

If the running driving power output device 200 includes both the engine and the driving motor, the engine ECU and the motor ECU work in cooperation with each other to control the running driving force in accordance with the information received from the running control section 160.

<Steering Device 210>

The steering device 210 may include, for example, a steering ECU and an electrical motor (these are not shown). The electrical motor is configured to turn wheels to be steered to change a direction of the wheels by applying a force to a rack-and-pinion mechanism. The steering ECU is configured to drive the electrical motor for changing the direction of the wheels in accordance with information inputted by the vehicle control apparatus 100 or input information on a steering angle or a steering torque.

<Braking Device 220>

The braking device 220 may be an electrically driven servo braking device including, for example, a brake caliper, a brake cylinder to apply a hydraulic pressure to the brake caliper, an electrical motor to generate a hydraulic pressure in the cylinder, and a braking control section (all of these are not shown). The braking control section of the electrically driven servo braking device is configured to control the electrical motor in accordance with the information input from the running control section 160 so that a brake force that is commensurate with a braking operation is applied to each wheel. In addition, the electrically driven servo braking device may include a mechanism to transmit the hydraulic pressure generated by an operation on a brake pedal to the brake cylinder through a master cylinder as a back-up system.

The braking device 220 is not limited to the electrically driven servo braking device as above described and may be an electrically controlled hydraulic pressure braking device instead. The electrically controlled hydraulic pressure braking device is configured to control an actuator in accordance with the information input from the running control section 160 to transmit a hydraulic pressure in the master cylinder to the brake cylinders. In addition, the braking device 220 may include a regenerative braking system with the driving motor that may be included in the running driving power output device 200.

<Vehicle-to-vehicle Communication Control Section 26>

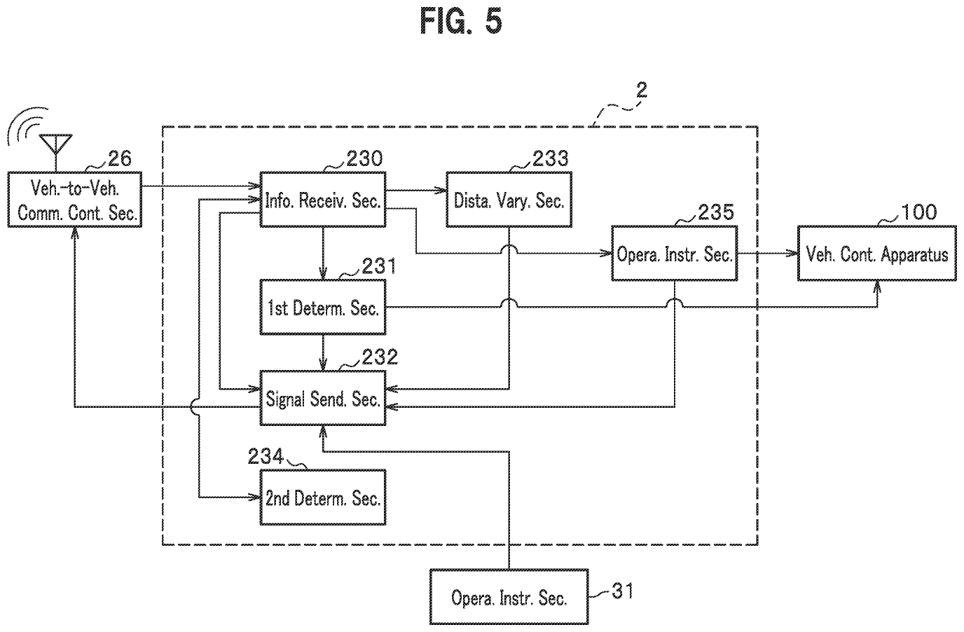

FIG. 5 is a functional block diagram illustrating how an information processing system 2 of the embodiment to be used for movable objects operates. The information processing system 2 is installed in the vehicle 1. The information processing system 2 includes components such as ECU. The information processing system 2 is connected with the vehicle-to-vehicle communication control section 26, which constitutes a part of the communication device 25 (See FIG. 2).

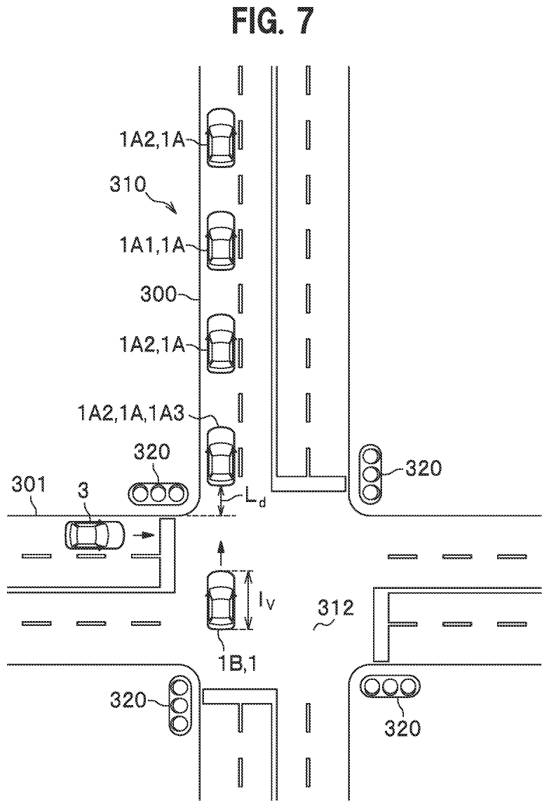

The vehicle-to-vehicle-to-vehicle communication control section 26 is a wireless communication control device through which the vehicle 1 (corresponding to a second movable object 1B in FIG. 7) performs vehicle-to-vehicle communicate with other vehicles (corresponding to first movable objects 1A in FIG. 7). The information processing system 2 is configured to perform processes to be described later through the vehicle-to-vehicle communication with the vehicle-to-vehicle communication control section 26. Then, the vehicle 1 can communicate with many other vehicles and this communication is preferably fast communication with little delay. Therefore, the vehicle-to-vehicle communication control section 26 is preferably a wireless communication interface with a 5G specification (fifth generation) or a higher specification.

<Information Processing System 2 for Movable Objects of the First Embodiment>

Each block of the information processing system 2 for movable objects in FIG. 5 is a functional block for a section of the information processing system 2 performing a corresponding process.

To begin with, an information receiving section 230 receives information on a distance L_{d} indicated in FIG. 7 from a rear end of a row 310 of plural first movable objects 1A to an intersection 312 that is a movable object stopping prohibited area indicated and information on a length l_{V} indicated in FIG. 7 of a second movable object 1B that is a driver's vehicle which is located or stopping rearward of a first movable object 1A3 located most rearward in the rows 310. The information on the distance L_{d} is received based on information received from the vehicle-to-vehicle communication control section 26 and with reference to the navigation map of the navigation device 20 or the precise map information 181 (See FIG. 2). Since the information on the length l_{V} is information on a length of the driver's vehicle, it may be received by reading information stored in a predetermined storage device of the driver's vehicle in advance. Since the second movable object 1B is autonomously driven, the second movable object 1B recognizes that it is located or stopping rearward of the first movable object 1A3.

The information receiving section 230 receives information on a slope of a road section 300 shown in FIG. 7 on which the row 310 of the plural first movable objects 1A are present.

A first determining section 231 determines whether the distance L_{d} and the length l_{V} meet a predetermined relation. To be specific, the first determining section 231 determines whether the distance L_{d}<the length l_{V} applies. The determination of the distance L_{d}<the length l_{V} may be replaced by the determination of the distance L_{d}±an amendment value Lα₁<the length l_{V} (Lα₁ is a predetermined value, this may apply to the rest of the specification).

A signal sending section 232 sends the first movable objects 1A forming the row 310 a signal inclusive of a first instruction to request that a gap distance between two consecutive movable objects be shortened to a first distance, if the first determining section 231 determines that the distance L_{d}<the length l_{V} applies in FIG. 7. This signal sending section 232 sends signals through the vehicle-to-vehicle communication control section 26.

A gap distance varying section 233 varies the first distance in accordance with information on the slope that the information receiving section 230 receives.

A second determining section 234 determines whether there is a first movable object 1A1 which does not execute the first instruction among the plural first movable objects 1A of the first row.

The signal sending section 232 sends the first movable objects 1A near the first movable object 1A1 a signal to instruct the first movable object 1A1 to send by broadcasting the driver's vehicle predetermined information. The signal sending section 232 sends signals through the vehicle-to-vehicle communication control section 26. The signal sending section 232 sends first movable objects 1A2 shown in FIG. 7 that have executed the first instruction a second signal inclusive of a second instruction that the gap distance between consecutive movable objects be shortened to a second distance, if the second determination section 234 determines that there is a first movable object 1A1 that does not execute the first instruction.

When this operation is performed, the signal sending section 232 may send the second instruction to at least one of a group of the first movable objects 1A2 shown in FIG. 7 which have executed the first instruction and are rearward of the first movable object 1A1 that does not execute the first instruction and a group of the first movable objects 1A2 shown in FIG. 7 that have executed the first instruction and are frontward of the first movable object 1A1.

In addition, when the second determining section 234 determines that there is a first movable object 1A1 that does not execute the first instruction, the signal sending section 232 may send the first movable objects 1A2 that have executed the first instruction and are located rearward of the first movable object 1A1 the second signal inclusive of the second instruction to further instruct the first movable objects 1A2 to perform a predetermined notifying action (such as headlight flashing).

The signal sending section 232 has to send signals for the first instruction and the second instruction before a third movable object 3 comes into the intersection 312 that is a movable object stopping prohibited area.

If the driver's vehicle is the first movable object 1A, it receives the first instruction and the second instruction from the second movable object 1B through the information receiving section 230.

Then, a control instructing section 235 sends the vehicle control apparatus 100 an instruction signal to instruct the vehicle control apparatus 100 (See FIG. 2) to perform a predetermined autonomous driving operation in accordance with the first or second instruction.

If the driver's vehicle is the first movable object 1A, the signal sending section 232 sends information on the autonomous driving of the driver's vehicle performed in accordance with the instruction by the control instructing section 235 to the second movable object 1B that has sent the first instruction and/or the second instruction.

In addition, the signal sending section 232 sends information on an inclination of the driver's vehicle detected by an inclination sensor 31 (See FIG. 2) that is one of the vehicle sensors 30 to detect the inclination of the vehicle to the second movable object 1B that has sent the first instruction and/or the second instruction.

<Action/Effect>

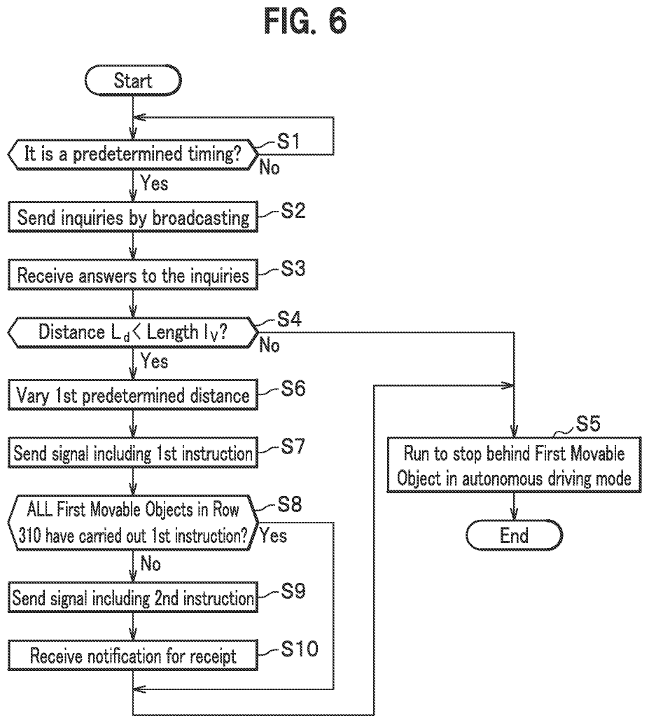

Next, processes to be performed by the information processing system 2 for movable objects as well as their actions and effects are explained. FIG. 6 is a flow chart illustrating processes to be performed by the information processing system 2 for movable objects when the vehicle 1 is the second movable object 1B. FIG. 7 shows a plan view of roads including their intersection illustrating the processes to be performed by the information processing system 2 for movable objects.

To begin with, FIG. 7 is explained schematically. FIG. 7 shows a plan view of the road 300 and the road 301 that cross each other at an intersection 312 showing a traffic state. Each of the road 300 and the road 301 is assumed to have two lanes on each side of the toad. A traffic light 320 is installed at the intersection 312. The second movable object 1B is running straight along the road 300 upward in FIG. 7 from a lower portion of FIG. 7 and is scheduled to pass through the intersection 312. However, there are plural first movable objects 1A forming a row 310 which are at a stop on the road 300 ahead of the intersection 312 due to a traffic congestion or a red light. A distance from a rear end of the first movable object 1A3 located most rearward in the row 310 of the plural first movable objects 1A to the intersection 312 that is a movable object stopping prohibited area is referred to as “L_{d}”. Then, a front-rear direction length of the second movable object 1B trying to pass through the intersection 312 is referred to as “l_{V}”.

The flow chart in FIG. 6 is explained with reference to FIG. 7. An information processing method for movable objects of the embodiment is performed by the information processing system 2 for movable objects in accordance with this flow chart. At first, the vehicle 1 that is the second movable object 1B being scheduled to pass through the intersection 312 starts the processes in FIG. 6 at a predetermined timing (Yes in Step S1). The predetermined timing is a timing when it is possible for the second movable object 1B to send signals including the first and second instructions to the first movable objects 1A before the third movable object 3 runs into the intersection 312. A timing when the third movable object 3 runs into the intersection 312 may be predicted by the second movable object 1B communicating wirelessly with an information providing server of Traffic Signal Prediction Systems (TSPS) through the communication device 25 and receiving information on a timing when the traffic light ahead of the third movable object 3 becomes blue or by the second movable object 1B communicating directly with the third movable object 3 through the communication device 25.

When it is at the predetermined timing (Yes in Step S1), the second movable object 1B sends predetermined inquiries to movable objects (vehicles) near the second movable object 1B through the signal sending section 232 by broadcasting (Step S2).

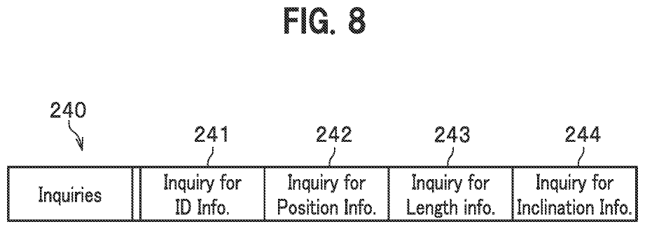

FIG. 8 shows an example of a data configuration of inquiries to be sent by the information processing system 2 for movable objects. These inquiries 240 may include an inquiry 241 for information on an ID (Identification) for identifying another movable object (vehicle). Requested ID information may be an IP address (Internet Protocol) of this movable object. The inquiries 240 may include an inquiry 242 for information on a detailed position of this other movable object. This position information can be obtained from the navigation device 20 of this movable object.

In addition, the requested position information may include information on which portion of another movable object corresponds to the position information (for example, a tip portion, a center portion in the longitudinal direction or a rear end portion of this other movable object. The inquiries 240 may include an inquiry 243 for information on a length in the front-rear direction of this other movable object. The inquiries 240 may include an inquiry 244 for information on the inclination of this movable object (corresponding to a slope of the road on which this movable object is at a stop).

When these inquiries are sent (in Step S2) as described in FIG. 6, the information receiving section 230 receives answers to the inquiries from each movable object nearby (in Step S3). In this Step, the information receiving section 230 usually receives the answers from plural movable objects. Moreover, these plural answers respectively include an answer to the inquiry 242 for the position information. Then, the information receiving section 230 determines the position of a movable object associated with each piece of the ID information (to be obtained as an answer to the inquiry 241 for the ID information) by checking each piece of the position information on the movable objects against the navigation map of the navigation device 20 or the precise map information 181 (See FIG. 2). As a result, each of the movable objects that has sent an answer can be identified as either one of the first movable objects 1A included in the row 310 shown in FIG. 7, or other movable object than these.

Then, the information receiving section 230 of the second movable object 1B discards answers other than those from the first movable objects 1A included in the row 310. Then, the information receiving section 230 can obtain information on current positions of the first movable objects 1A in the row 310 that have sent back the answers and a gap distance between any two first movable objects 1A located next to each other in the row 310 based on the position information on the movable objects 1A and the information on the length in the front-rear direction of a vehicle body of each movable object 1A in the row 310, both of which are provided by the first movable objects 1A included in the row 310. In addition, the information receiving section 230 can receive information on a distance L_{d} from a rear end of the first movable object 1A3 (See FIG. 7) located most rearward in the row 310 to the intersection 312 that is a movable object stopping prohibited area. In addition, the information receiving section 230 receives information on a length l_{V} in the vehicle front-rear direction of the driver's vehicle that is stored in a predetermined portion of a non-volatile memory device (Step S3).

Next, the first determining section 231 determines whether the condition of “the distance L_{d}<the length l_{V}” applies (Step S4). If this condition is not met (No in Step S4), the length l_{V} of the second movable object 1B is equal to or smaller than the distance L_{d}. In this case, the second movable object 1B can run to pass through the intersection 312 and stop just rearward of the first movable object 1A3 located rearmost in the row 310.

If the distance L_{d} is equal to the length l_{V} or their difference is small, the second movable object 1B is likely to have its rear portion protrude into the intersection 312 when the second movable object stops just rearward of the first movable object 1A3, because there has to be some gap between the second movable object 1B and the first movable object 1A3. However, the protruding length of the rear portion of the second movable object in the intersection 312 is so small that the second movable object that is at a stop rearward of the first movable object 1A3 is likely not to be in the way of the third movable object 3 passing the intersection 312. Accordingly, in this case, the first determining section 231 outputs a control signal to the vehicle control apparatus 100 to instruct the vehicle control apparatus 100 to autonomously drive the driver's vehicle (second movable object 1B) to pass the intersection 312 and stop rearward of the first movable object 1A3 (Step S5).

On the other hand, if the condition of “the distance L_{d}<the length l_{V}” is met (Yₑₛ in Step S4), the driver's vehicle (second movable object 1B) necessarily has its rear portion protrude into the intersection 312, which can disrupt the third movable object 2 passing through the intersection 312, if the second movable object 1B runs to stop rearward of the first movable object 1A3. Then, the signal sending section 232 sends each of the first movable objects 1A in the row 310 a signal including a first instruction to instruct each of the first movable objects 1A to shorten the gap distance of movable objects next to each other (vehicle-to-vehicle distance) to a first distance (Step S7). Before the signal is sent, the gap distance varying section 233 determines the slope of the road 300 on which each of the first movable objects 1A is at a stop based on the answer to the inquiry 244 for inclination information included in the answers to the inquiries (Step S3) that the information receiving section 230 receives. The gap distance varying section 233 varies the first distance to be indicated in Step S7 in accordance with how large the slope is (Step S6). In this case, if the slope is large whether the slope is upward or downward, the first distance is preferably made longer in Step S6, since there is a risk that the first movable object 1A could move unexpectedly. The larger the slope is, the longer the first distance may be. In addition, the signal including the first instruction (Step S7) may include an instruction to instruct each of the first movable objects 1A that receives the signal including the first instruction to send back a notification that it has carried out the first instruction.

The second determining section 234 determines whether all the first movable objects 1A in the row 310 have carried out the first instruction (Step S8). In a case as shown in FIG. 7, the first movable object 1A1 that is located second from the frontmost first movable object 1A does not carry out the first instruction. The first movable object 1A1 is equipped with a vehicle-to-vehicle communication system but is not capable of performing the level 4 or a higher-level autonomous driving. As a result, the first movable object 1A1 sends back the notification to the second movable object 1B that it has not carried out the first instruction, and the second movable object 1B recognizes that the first movable object 1A1 has not carried out the first instruction. Furthermore, in case the first movable object 1A1 is not equipped with the vehicle-to-vehicle communication system, the first movable object 1A1 cannot respond to the inquiry from the second movable object 1B. In this case, since the second determining section 234 recognizes that there is a space in the row 310 that is large enough to have a movable object at a stop and in which there is no first movable object 1A2 that has carried out the first instruction, based on the position information received by the second movable object 1B on the first movable objects 1A2 that have carried out the first instruction, the second determining section 234 presumes that the first movable object 1A1 that does not carry out the first instruction is at a stop in the space. Additionally, the second determining section 234 can further check that there is certainly a movable object in the space with the external world sensor 10 such as the camera 11 (See FIG. 2).

When the second determining section 234 checks that there is a first movable object 1A1 that does not carry out the first instruction (No in Step S8) as described above, the signal sending section 232 sends the first movable objects 1A2 in the row 310 that have carried out the first instruction a signal including a second instruction to shorten the gap distances between movable objects next to each other (vehicle-to-vehicle distance) to a second distance that is shorter than the first distance (Step S9). In this case, an instruction to instruct the first movable objects 1A2 to send back a notification that the second instruction has been carried out is sent to the first movable objects 1A2 together with the second instruction. In this case, the signal sending section 232 may sends the second instruction to at least one of a first group of the first movable objects 1A2 that have carried out the first instruction and are frontward of the first movable object 1A1 that does not carry out the first instruction and a second group of the first movable objects 1A2 that have carried out the first instruction and are rearward of the first movable object 1A1. In the case as shown in FIG. 7, if the second instruction is sent to the first movable object 1A2 that has carried out the first instruction and is just rearward of the first movable object 1A1 that does not carry out the first instruction, the gap distance between the first movable object 1A1 and this first movable object 1A2 is shortened so that there is a larger gap made between the first movable object 1A2 and the first movable object 1A3 located just rearward of the first movable object 1A3 and rearmost in the row 310 after the first movable object 1A2 carries out the second instruction. This larger gap is shortened by the first movable object 1A3 located rearmost in the row 310 moving forward according to the second instruction.

When the information receiving section 230 receives from the first movable objects 1A2 that has carried out the first instruction the notification that it has carried out the second instruction (Step S10), the control instructing section 235 outputs a control signal to the vehicle control apparatus 100 (See FIG. 2). By outputting the control signal, the control instructing section 235 has the vehicle control apparatus 100 perform autonomous driving so that the second movable object 1B is running to pass through the intersection 312 and stop behind the first movable object 1A3 located rearmost in the row 310 (Step S5). When all the first movable objects 1A in the row 310 have carried out the first instruction, the process of Step S5 is performed. The aforementioned is what the vehicle 1 performs when the vehicle 1 is the second movable object 1B. When the vehicle 1 is a first movable object 1A, the following is generally what the vehicle 1 performs. That is, the information receiving section 230 receives from the second movable object 1B the inquiries, the first instruction, the second instruction and the like. Then, the signal sending section 232 sends the second movable object 1B answers to the inquiries from the second movable object 1B. When the first instruction or the second instruction is received, the control instructing section 235 outputs the control signal to the vehicle control apparatus 100 (See FIG. 2) to perform the received instruction with autonomous driving. The signal sending section 232 sends back the notification that the first instruction or the second instruction has been carried out to the second movable object 1B.

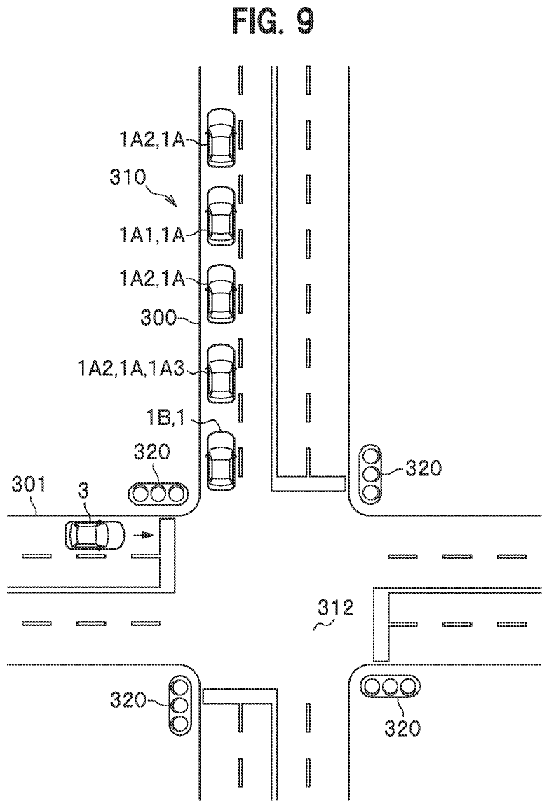

The information processing system 2 for movable objects as has been described sends the plural first movable objects 1A forming the row 310 the first instruction to shorten the gap distances between movable objects next to each other (vehicle-to-vehicle distance) to the first distance (Step S7), if “the distance L_{d}<the length l_{V}” applies. As a result, the first movable objects 1A forming the row 310 move to shorten the vehicle-to-vehicle distances so that the second movable object 1B can run to pass through the movable object stopping prohibited area (intersection section 312) and stop most rearward in the row 310 with the rear portion of the second movable object 1B hardly protruding into the intersection 312 (corresponding to a state shown in FIG. 9). Therefore, the second movable object 1B after running to stop hardly disrupts the third movable object 3 passing through the intersection 312.

In this case, the information on the slope of the road 300 is obtained (Step S3), and then the first distance is varied according to the information on the slope of the road 300 (Step S6). Accordingly, the first movable objects can shorten their vehicle-to-vehicle distances to an appropriate vehicle-to-vehicle distance.

In addition, when there is a first movable object 1A1 in the row 310 that does not carry out the first instruction (No in Step S8), the second instruction is sent to the first movable objects 1A2 that have carried out the first instruction, the second instruction instructing the first movable objects 1A2 to shorten the gap distance between movable objects next to each other (vehicle-to-vehicle distance) to the second distance that is shorter than the first distance (Step S9). As a result, even when there is a first movable object 1A1 in the row 310 that does not contribute to shortening the vehicle-to-vehicle distances, the vehicle-to-vehicle distances can be sufficiently shortened by the first movable objects 1A2.

This second instruction is sent to at least one of a first group of the first movable objects 1A2 that have carried out the first instruction and are located frontward of the first movable object 1A1 and a second group of the first movable objects 1A2 that have carried out the first instruction and are located rearward of the first movable object 1A1. Thus, even when there is a first movable object 1A1 in the row 310 that does not move to shorten the vehicle-to-vehicle distance, the first movable objects 1A2 can manage to efficiently shorten the vehicle-to-vehicle distances.

The first and second instructions are sent before the third movable object 3 runs into the intersection 312 (Yes in Step S1), which enables the second movable object 1B to pass through the intersection 312 without disrupting the third movable object 3 running.

Additionally, instead of the second instruction being sent, another instruction may be sent to the first movable objects 1A2 that have moved to shorten the vehicle-to-vehicle distances in response to the second instruction and are located rearward of the first movable object 1A1 that has not moved to shorten the vehicle-to-vehicle distance, the instruction to instruct these first movable objects 1A2 to perform a predetermined notifying action such as headlight flashing. The first movable object 1A1 that has not moved to shorten the vehicle-to-vehicle distance is expected to notice this action and move to shorten the vehicle-to-vehicle distance.

It should be noted that the above description on the present invention does not limit the scope of the present invention. For instance, when there is a space left on an adjacent lane (See FIG. 7), the first movable object 1A2 to carry out the first instruction may move to the space on the adjacent lane, instead of moving frontward to shorten the vehicle-to-vehicle distance, so that the second movable object 1B can run to stop most rearward in the row 310.

In addition, the first movable objects 1A are oriented in the same direction in the example as described above. However, there may be a first movable object 1A in the row 310 oriented in a different direction.

<Information Processing System 2 for Movable Objects of the Second Embodiment>

Each functional block of the information processing system 2 for movable objects in FIG. 5 is a functional block for a section of the information processing system 2 performing a corresponding process. Many of the functional blocks in FIG. 5 are usually in operation when the vehicle 1 becomes the second movable object 1B. Therefore, an operation of each functional block in FIG. 5 for the second embodiment when the vehicle 1 is the second movable object 1B is mainly described below.

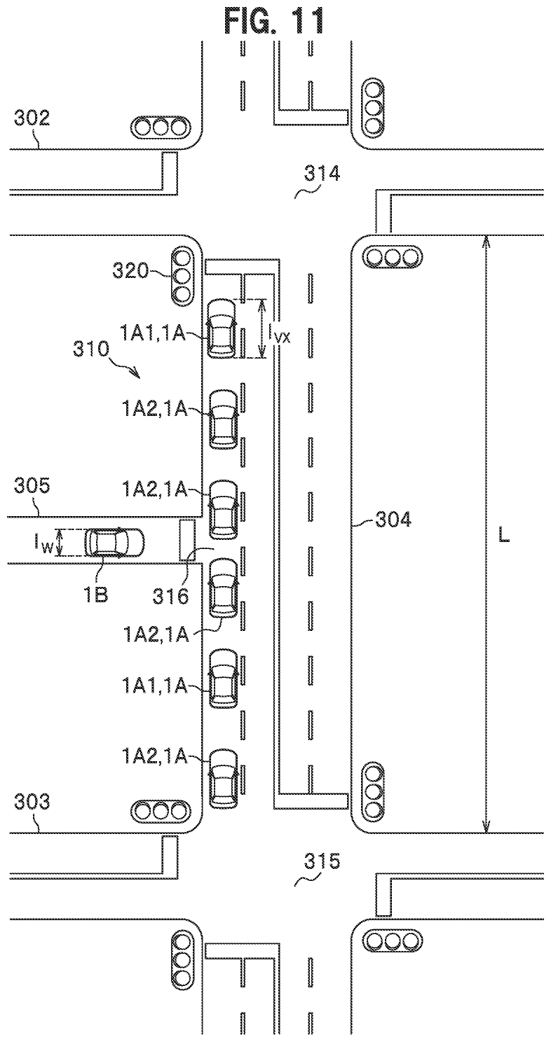

To begin with, the information receiving section 230 receives information on a distance L between an intersection 314 and an intersection 315, each of which is a movable object stopping prohibited area frontward or rearward of the plural first movable objects 1A as shown in FIG. 11. The intersection 314 is a movable object stopping prohibited area frontward of the first movable objects 1A forming a row 310 and the intersection 315 is a movable object stopping prohibited area rearward of the first movable objects 1A forming the row 310. In addition, the information receiving section 230 receives information on a length l_{VX} of each of the first movable objects 1A forming the row 310 as well. In addition, the information receiving section 230 receives information on a width l_{W} of a second movable object 1B that is going to run into a road 304 on which the row 310 are at a stop. he information on the distance L can be obtained from the navigation map of the navigation device 20 or the precise map information 181 (See FIG. 2). The information on the length l_{VX} of each of the first movable objects 1A can be received from the first movable objects 1A through vehicle-to-vehicle communication through the vehicle-to-vehicle communication control section 26. The information on the width l_{W} of the second movable object 1B that is a driver's vehicle is stored in a storage device of the driver's vehicle and can be retrieved from it.

The information receiving section 230 receives information on a slope of the road 304 on which the first movable objects 1A forming the row 310 exist as shown in FIG. 11 as well.

The first determining section 231 determines whether a predetermined relation of the distance L and the lengths l_{VX}, which is specifically a condition of “L>Σl_{VX}+l_{W}”, is met based on the information received by the information receiving section 230. Instead of determining whether “L>Σl_{VX}+l_{W}” applies, whether “L>Σl_{VX}+l_{W}+La₂” (La₂ is a predetermined value) applies may be determined (this is the case with the description below).

A signal sending section 232 sends a signal to the first movable objects 1A forming the row 310 if the first determining section 231 determines that “L>Σl_{VX}+l_{W}” in FIG. 11 applies. That is, the signal sending section 232 sends the first movable objects 1A the signal including a first instruction to instruct the first movable objects 1A to move to shorten gap distances between first movable objects 1A next to each other (vehicle-to-vehicle distance) to a first distance to form a space in the row 310 in an entering area (intersection 316) to the road 304, the space being wider than the width length l_{W}, so that the second movable object 1B is able to run through the space into the road 304. The signal sending section 232 sends data through the vehicle-to-vehicle communication section 26.

The gap distance varying section 233 varies the first distance in accordance with the information on the slope that the information receiving section 230 receives.

The second determining section 234 determines whether there is a first movable object 1A1 among the first movable objects 1A forming the row 310 in FIG. 11, which does not carry out the first instruction.

The signal sending section 232 sends, by broadcasting, the first movable objects 1A nearby a signal to instruct the first movable objects 1A to send the driver's vehicle predetermined information. The signal sending section 232 sends data through the vehicle-to-vehicle communication control section 26. When the second determining section 234 determines that there is a first movable object 1A1 that does not carry out the first instruction, the signal sending section 232 sends a signal including a second instruction to shorten the gap distance between movable objects next to each other to a second distance that is shorter than the first distance to the first movable objects 1A2 of the first movable objects 1A in FIG. 11 that have carried out the first instruction.

The signal sending section 232 may send the second instruction to at least one of a first group of the first movable objects 1A2 that have carried out the first instruction and are located frontward of the first movable object 1A1 that does not carry out the first instruction and a second group of the first movable objects 1A2 that have carried out the first instruction and are located rearward of the first movable object 1A1.

Alternatively, or additionally, when the second determining section 234 determines that there is a first movable object 1A1 that does not carry out the first instruction, the signal sending section 232 may send the first movable objects 1A2 that have carried out the first instruction and are located rearward of the first movable object 1A1 a signal including a second instruction to instruct the first movable objects 1A2 to perform a predetermined notifying action such as headlight flashing.

Here, when the driver's vehicle is a first movable object 1A, the information receiving section 230 receives the first and second instructions from the second movable object 1B.

When the vehicle 1 is a first movable object 1A, the control instructing section 235 outputs to the vehicle control apparatus 100 (See FIG. 2) a signal to instruct the vehicle control apparatus 100 to perform a predetermined autonomous driving operation in accordance with the first or second instruction.

When the vehicle 1 is a first movable object 1A, the signal sending section 232 sends information on the autonomous driving operation performed in accordance with the instruction from the control instructing section 235 to the second movable object 1B that has sent the first or second instruction to the vehicle 1.

In addition, when the driver's vehicle is a first movable object 1A, the signal sending section 232 sends information on an inclination of the driver's vehicle detected by the inclination sensor 31 that is one of the vehicle sensors 30 to detect the inclination of a vehicle to the second movable object 1B that has sent the first or second instruction.

<Action/Effect>

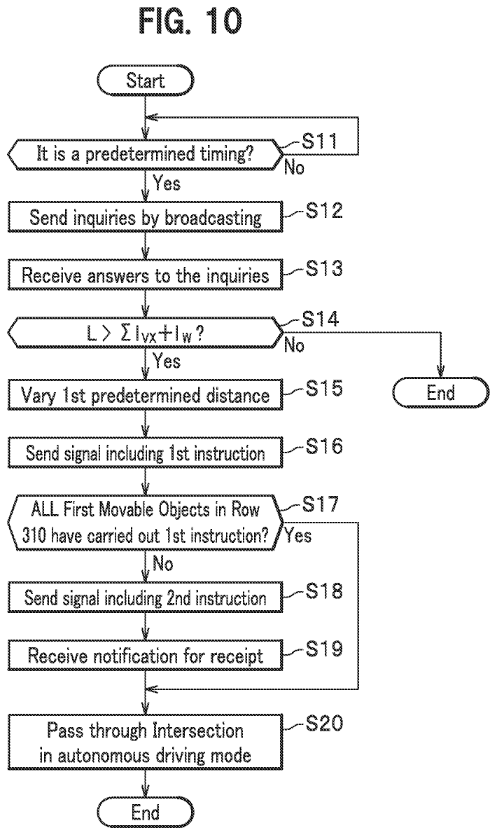

Next, processes to be performed by the information processing system 2 for movable objects of the second embodiment as well as their actions and effects are explained. FIG. 10 is a flow chart illustrating processes to be performed by the information processing system 2 for movable objects of the second embodiment when the vehicle 1 is the second movable object 1B. FIG. 11 is a plan view of roads for illustrating processes to be performed by the information processing system 2 for movable objects.

To begin with, FIG. 11 is schematically explained in brief. A road 304 having two lanes each way extends in an up-down direction in FIG. 11. The road 304 intersects with roads 302, 303 to form intersection 314, 315 respectively, as seen in FIG. 11. A road 305 is extended to be connected to an intermediate portion of the road 304 between the intersections 314, 315. Thus, the intermediate portion forms an intersection 316 that may form a T-junction (or a crossroad). Since the road 305 is a relatively narrow road, there is no traffic light at the intersection 316. In an example as shown in FIG. 11, there are plural first movable objects 1A at a stop in a row forming a row 310 on the left lane of the road 304. Therefore, the second movable object 1B, which is going to run from the road 305 through the intersection 316 into the right lane of the road 304 in FIG. 11, is in a state of being unable to run into the intersection 316 with the row 310 of the first movable objects 1A being in the way. The distance between the intersections 314, 315 that are a movable object stopping prohibited area is referred to as “L”. The length in the front-rear direction of each first movable object is referred to as “l_{VX}”. The lengths l_{VX} of the first movable objects 1A vary because their vehicle types differ. The width of the second movable object 1B is referred to as “l_{W}”.

The flow chart in FIG. 10 is explained with reference to FIG. 11. When the second movable object 1B is in a “predetermined state” (Yes in Step S11), the signal sending section 232 of the second movable object 232 sends predetermined inquiries to movable objects (vehicles) near the second movable object 1B by broadcasting (Step S12). The “predetermined state” is a state in which the second movable object 1B, which is going to run from the road 305 into the road 304, is in a state of being kept stopped from running into the intersection 316 with no traffic light by the first movable objects 1A on the road 305 forming the row 310 and blocking the intersection 316. The second movable object 1B can determines with the external world sensor 10 such as the cameras 11 whether there is a traffic light at the intersection 316 and that the intersection 310 is blocked by the row 310 of the first movable objects 1A. Additionally, the second movable object 1B can determine whether there is a traffic light with the navigation map of the navigation device 20 or the precise map information 181 (See FIG. 2) as well. If there is a traffic light installed at the intersection 316, the second movable object 1B has only to wait for the traffic light to turn green to have a space made in the intersection 316 and the processes in FIG. 10 are unnecessary.

The data configuration of inquiries that the second movable object 1B sends in the inquiry Step S12 is the same as the data configuration of inquiries shown in FIG. 8 that the second movable object 1B sends in the inquiry step in the flow chart in FIG. 6 to explain the processes to be carried out by the information processing system 2 for movable objects of the first embodiment. The content of each inquiry in Step S12 is the same as a corresponding inquiry in Step S2 for the first embodiment. Therefore, the inquiries 240 in Step S12 includes an inquiry 243 for information on the length l_{VX} in the front-rear direction of a vehicle body of the movable object that receives the inquiry.

When the second movable object 1B sends the inquiries (Step S12 in FIG. 10), the information receiving section 230 of the second movable object 1B receives answers to the inquiries from each of the movable objects near the second movable objects 1B (Step S13). In this case, answers are received usually from plural movable objects, depending on the traffic state nearby. Then, the answers from the plural movable objects respectively include an answer to the inquiry 242 for the position information. By comparing each piece of the position information to the navigation map of the navigation device 20 or the precise map information 181 (See FIG. 2), the information receiving section 230 of the second movable object 1B determines a presence position of each of movable objects associated with a piece of ID information (to be received as an answer to the inquiry 241 for ID information). As a result of this determination, each movable object that has answered can be determined to be either a first movable object 1A included in the row 310 shown in FIG. 11 or another movable object that is not included in the row 310. Then, the information receiving section 230 of the second movable object 1B discards answers other than those from the first movable objects 1A included in the row 310. Then, the information receiving section 230 can obtain information on the current position of each of the first movable objects 1A and a gap distance between any two first movable objects 1A located next to each other in the row 310, based on the position information on the first movable objects and the information on the length l_{VX} in the front-rear direction of a vehicle body, both of which are provided by each of the first movable objects 1A included in the row 310. In addition, the information receiving section 230 of the second movable object 1B obtains information on the distance L of the road 304 between the intersections 314, 315 which are respectively movable object stopping prohibited areas ahead of and behind the first movable objects 1A forming the row 310 from the navigation map of the navigation device 20 or the precise map information 181 (See FIG. 2).

Furthermore, the information receiving section 230 of the second movable object 1B retrieves information on the width l_{W} of the driver's vehicle stored in a predetermined area of a non-volatile storage device of the driver's vehicle (Step S13). A distance of the row 310 can be estimated based on the position information on the frontmost first movable object 1A and the rearmost first movable object 1A in the row 310.

Next, the first determining section 231 of the second movable object 1B determines whether “L>Σl_{VX}+l_{W}” applies based on the received information (Step S14). If this condition is met, a distance that is a summation of a width l_{W} of the driver's vehicle (second movable object 1B) and a summation Σl_{VX} of the lengths l_{VX} of all the first movable objects 1A is shorter than the distance L of the road 304 from the intersection 314 to the intersection 315. Then, if “L>Σl_{VX}+l_{W}” applies, it is possible to make a space in the intersection 316 through which the second movable object 1B runs to pass the intersection 316 by having the first movable objects 1A forming the row 310 shorten the gap distances between movable objects next to each other (vehicle-to-vehicle distance). Then, if “L>Σl_{VX}+l_{W}” applies (Yes in Step S14), the processing operation goes to Step S15 and Step S16.

On the other hand, if the first movable objects 1A attempt to shorten the vehicle-to-vehicle gap distances to make a space for the second movable object 1B that is the driver's vehicle to pass through when L≤Σl_{VX}+l_{W} (No in Step S14), the first movable object 1A at a front or rear end of the row 310 protrudes respectively into the intersection 314 or the intersection 315. Therefore, if L≤Σl_{VX}+l_{W}, the processing operation shown in FIG. 10 ends. In this case, the second movable object 1B waits until a space for the second movable object 1B that is the driver's vehicle to pass through is made after all or part of the first movable objects 1A included in the row 310 move, and passes through the intersection 316.

In Step S16, the signal sending section 232 of the second movable object 1B sends each of the first movable objects 1A a signal including an instruction to instruct the first movable object 1A to shorten the gap distance between movable objects next to each other to a first distance (Step S17). In this case, the signal sending section 232 of the second movable object 1B sends the first movable objects 1A the first instruction to instruct the first movable objects 1A to move to shorten vehicle-to-vehicle distances to make a gap wider than the width l_{W} of the second movable object 1B in an entering area to the road 304 so that the second movable object 1B that is the driver's vehicle is able to run through the gap into the road 304. To be specific, the first movable objects 1A in the row 310 located between the intersection 316 and the intersection 314 are instructed to move frontward to shorten the vehicle-to-vehicle distances and the first movable objects 1A in the row 310 located between the intersection 316 and the intersection 315 are instructed to move rearward to shorten the vehicle-to-vehicle distances. In this case, passengers on the first movable objects 1A in the row 310 possibly feel odd when an ahead-located vehicle moves rearward. If this case is taken into consideration, the first movable objects 1A located between the intersection 316 and the intersection 314 may be instructed to move frontward to shorten the vehicle-to-vehicle distance while the first movable objects 1A located between the intersection 316 and the intersection 315 may not be instructed to move rearward to shorten the vehicle-to-vehicle distance.

Before sending the first instruction (Step S16), the gap distance varying section 233 of the second movable object 1B determines the slope of the road 304 on which each of the first movable objects 1A is at a stop based on the answer to the inquiry 244 included in the answers to the inquiries received by the information receiving section 230 (Step S13). The gap distance varying section 233 varies the first distance to be indicated in Step S17 in accordance with how large the slope is (Step S15). In this case, if the slope is large whether the slope is upward or downward, the first distance is made longer in Step S16, since there is a risk that the first movable object 1A could move unexpectedly. The larger the slope is, the longer the first distance may be. In addition, the signal including the first instruction (Step S16) may include an instruction to instruct each of the first movable objects 1A that receives the signal including the first instruction to send back a notification that it has carried out the first instruction.

The second determining section 234 of the second movable object 1B determines whether all the first movable objects 1A in the row 310 have carried out the first instruction (Step S17). In a case as shown in FIG. 11, the first movable object 1A1 that is located at a frontmost position in the row 310 does not carry out the first instruction. The first movable object 1A1 is equipped with a vehicle-to-vehicle communication system but is not capable of performing the level 4 or a higher-level autonomous driving. As a result, the first movable object 1A1 sends back the notification that it has not carried out the first instruction and the second movable object 1B recognizes that the first movable object 1A1 has not carried out the first instruction. Furthermore, in case the first movable object 1A1 is not equipped with the vehicle-to-vehicle communication system, the first movable object 1A1 cannot respond to the inquiry from the second movable object 1B. In this case, the second movable object 1B receives the position information on the first movable objects 1A2 that have carried out the first instruction. As a result, when the second determining section 234 of the second movable object 1B recognizes that there is a space in the row 310 that is large enough to have a movable object at a stop and in which there is no first movable object 1A2 that has carried out the first instruction, the second determining section 234 presumes that the first movable object 1A1 that does not carry out the first instruction is at a stop in the space. Additionally, the second determining section 234 can further check that there is certainly a movable object in the space with the external world sensor 10 such as the camera 11 (See FIG. 2).

When the second determining section 234 of the second movable object 1B checks that there is a first movable object 1A1 that does not carry out the first instruction (No in Step S17) as described above, the signal sending section 232 sends the first movable objects 1A2 in the row 310 that have carried out the first instruction a signal including a second instruction to shorten the gap distances between movable objects next to each other (vehicle-to-vehicle distance) to a second distance that is shorter than the first distance (Step S18). In this case, an instruction to instruct the first movable objects 1A2 to send back a notification that the second instruction has been carried out may be sent to the first movable objects 1A2 together with the second instruction. In this case, the signal sending section 232 may sends the second instruction to at least one of a first group of the first movable objects 1A2 that have carried out the first instruction and are frontward of the first movable object 1A1 that does not carry out the first instruction and a second group of the first movable objects 1A2 that have carried out the first instruction and are rearward of the first movable object 1A1. In the case as shown in FIG. 11, since the second instruction is sent to the second group of the first movable objects 1A2 that have carried out the first instruction and are rearward of the first movable object 1A1 that does not carry out the first instruction, the gap distance between the first movable object 1A1 and the first movable object 1A2 just rearward of the first movable object 1A1 and the gap distance between the first movable objects 1A2 next to each other are shortened so that there is a larger space made in the intersection 316.

When the information receiving section 230 of the second movable object 1B receives from the first movable objects 1A2 that have carried out the first instruction the notification that the second instruction has been carried out (Step S19), the control instructing section 235 of the second movable object 1B outputs a control signal to the vehicle control apparatus 100 (See FIG. 2).

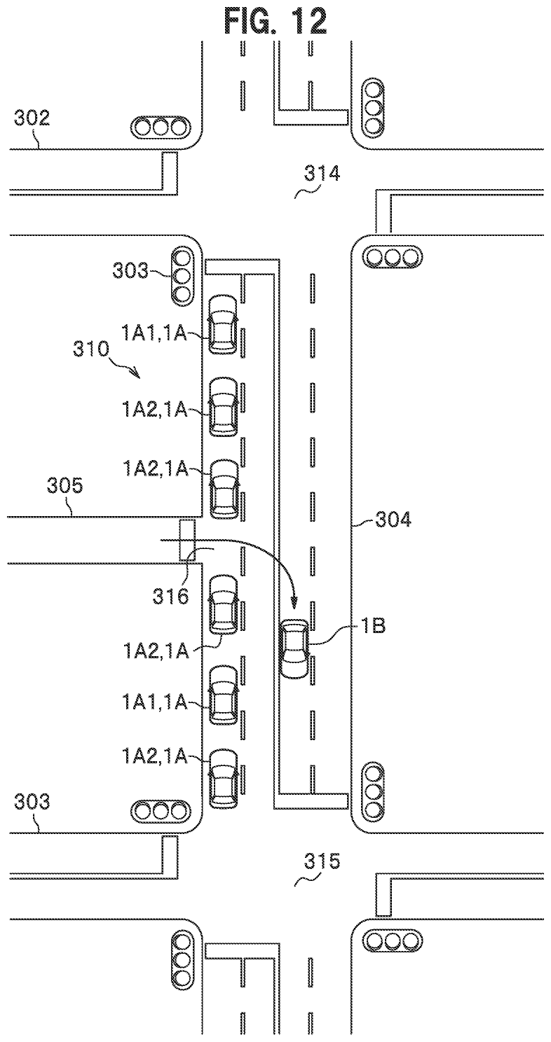

By outputting the control signal, the control instructing section 235 of the second movable object 1B has the vehicle control apparatus 100 perform autonomous driving so that the second movable object 1B is running to pass through the intersection 316 (Step S20) (See FIG. 12). When all the first movable objects 1A in the row 310 have carried out the first instruction, the process of Step S20 is also performed by the control instructing section 235 of the second movable object 1B.

The aforementioned is what the vehicle 1 performs when the vehicle 1 is the second movable object 1B. When the vehicle 1 is the first movable object 1A, the following is generally what the vehicle 1 performs. That is, the information receiving section 230 receives from the second movable object 1B the inquiry, the first instruction, the second instruction and the like. Then, the signal sending section 232 sends the second movable object 1B answers to the inquiries from the second movable object 1B. When the first instruction or the second instruction is received, the control instructing section 235 outputs the control signal to the vehicle control apparatus 100 (See FIG. 2) to perform the received instruction with autonomous driving. The signal sending section 232 sends back the notification that the first instruction or the second instruction has been carried out to the second movable object 1B.

The information processing system 2 for movable objects of the second embodiment as has been described sends the plural first movable objects 1A forming the row 310 the first instruction to shorten the gap distances between movable objects next to each other (vehicle-to-vehicle distance) to the first distance (Step S17), if “the distance “L<Σl_{VX}+l_{W}” applies. As a result, a gap wider than the width l_{W} of the second movable object 1B is made in an entering area to the road 304 so that the second movable object 1B runs through the gap into the road 304. Accordingly, the second movable object 1B that is the driver's vehicle and is running on the road 305 can smoothly run into the inter section 316 that may be a T-junction, a crossroad or the like, the road 305 being connected to the road 304 at the inter section 316, even if there are first movable objects 1A at a stop in a row on the road 304 running across the intersection 316 when the second movable object 1B is going to run into the intersection 316.

In this case, the first distance is varied (Step S16) according to the information on the slope of the road 304 that is received (Step S13). Therefore, the first movable objects 1A can move to shorten the vehicle-to-vehicle distances to an appropriate vehicle-to-vehicle distance.

In addition, in case there is a first movable object 1A1 in the row 310 that does not carry out the first instruction (No in Step S18), the signal including the second instruction is sent to the first movable objects 1A2 that have carried out the first instruction, the second instruction instructing the first movable objects 1A2 to move to shorten the gap distances between first movable objects 1A next to each other (vehicle-to-vehicle distance) to the second distance shorter than the first distance (Step S19). As a result, even if there is a first movable object 1A1 in the row that does not move to shorten the vehicle-to-vehicle distance, the first movable objects 1A2 can manage to sufficiently shorten the vehicle-to-vehicle distances. This second instruction is sent to at least one of a first group of the first movable objects 1A2 that have carried out the first instruction and are located frontward of the first movable object 1A1 and a second group of the first movable objects 1A2 that have carried out the first instruction and are located rearward of the first movable object 1A1. Thus, even when there is a first movable object 1A1 in the row 310 that does not move to shorten the vehicle-to-vehicle distance, the first movable objects 1A2 can manage to efficiently shorten the vehicle-to-vehicle distances.

Additionally, instead of the second instruction being sent, another instruction may be sent to the first movable objects 1A2 that have moved to shorten the vehicle-to-vehicle distances in response to the second instruction and are located rearward of the first movable object 1A1 that has not moved to shorten the vehicle-to-vehicle distance, the other instruction instructing these first movable objects 1A2 to perform a predetermined notifying action such as headlight flashing. The first movable object 1A1 is expected to voluntarily shorten the gap between itself and a first movable object 1A2 next to itself in response to this notifying action.

It should be noted that the above description on the present invention does not limit the scope of the present invention. For instance, when there is a space left on an adjacent lane (See FIG. 11), the first movable object 1A2 to carry out the first instruction may move to the space, instead of moving frontward to shorten the vehicle-to-vehicle distances, so that the movable object 1A2 can move to further shorten the vehicle-to-vehicle distances.

In addition, the first movable objects 1A are oriented in the same direction in the example as described above. However, there may be a first movable object 1A oriented in a different direction in the row 310.

What is claimed is:

1. An information processing system for movable objects including a processor comprising;
an information receiving section receiving information on a distance L_{d} from a rear end of a most rearward first movable object located most rearward in a row of plural first movable objects on a road to a movable object stopping prohibited area and a length l_{V} of a second movable object that is stopping or scheduled to stop behind the most rearward first movable object;
a first determining section determining whether the distance L_{d} and the length l_{V} that are received by the information receiving section meet a predetermined condition; and
a signal sending section sending the plural first movable objects forming the row on the road a signal including a first instruction to instruct the plural first movable objects to shorten a gap distance between the first movable objects next to each other to a first distance, if the first determining section determines that the distance L_{d} and the length l_{V} meet the predetermined condition.

2. An information processing system for movable objects including a processor comprising;
an information receiving section receiving information on a distance L between two movable object stopping prohibited areas between which there is a row of plural first movable objects at a stop on a first road, a length l_{VX} of each of the plural first movable objects and a width l_{W} of a second movable object running on a second road that is attempting to run into the first road crossing the second road;
a first determining section determining whether the distance L, the lengths l_{VX} and the width l_{w} that are received by the information receiving section meet a predetermined condition; and
a signal sending section sending the plural first movable objects a first signal including a first instruction to instruct the plural first movable objects to shorten a gap distance between movable objects next to each other to a first distance to make a gap wider than the width l_{W} in an entering area to the first road so that the second movable object is able to run through the gap into the first road, if the first determining section determines that the distance L, the lengths l_{VX} and the width l_{W} meet the predetermined condition.

3. The information processing system for movable objects as claimed in claim 1, wherein the information receiving section receiving slope information on a slope of the road on which the row of the plural first movable objects is present, further comprising a gap distance varying section varying the first distance in accordance with the slope information.

4. The information processing system for movable objects as claimed in claim 2, wherein the information receiving section receiving slope information on a slope of the first road on which the row of the plural first movable objects is present, further comprising a gap distance varying section varying the first distance in accordance with the slope information.

5. The information processing system for movable objects as claimed in claim 1, further comprising a second determining section determining whether there is a first movable object in the row of the plural first movable objects that does not carry out the first instruction,
wherein the signal sending section sends a second signal including a second instruction to shorten the gap distance between the first movable objects next to each other to a second distance that is shorter than the first distance to the first movable objects in the row of the plural first movable objects that have carried out the first instruction, if the second determining section determines that there is a first movable object in the row of the plural first movable objects that does not carry out the first instruction.

6. The information processing system for movable objects as claimed in claim 2, further comprising a second determining section determining whether there is a first movable object in the row of the plural first movable objects that does not carry out the first instruction,
wherein the signal sending section sends a second signal including a second instruction to shorten the gap distance between the first movable objects next to each other to a second distance that is shorter than the first distance to the first movable objects in the row of the plural first movable objects that have carried out the first instruction, if the second determining section determines that there is a first movable object in the row of the plural first movable objects that does not carry out the first instruction.

7. The information processing system for movable objects as claimed in claim 5, wherein the signal sending section sends the second signal to at least one of a first group of the first movable objects that have carried out the first instruction and are located frontward of the first movable object that does not carry out the first instruction and a second group of the first movable objects that have carried out the first instruction and are located rearward of the first movable object that does not carry out the first instruction.

8. The information processing system for movable objects as claimed in claim 6, wherein the signal sending section sends the second signal to at least one of a first group of the first movable objects that have carried out the first instruction and are located frontward of the first movable object that does not carry out the first instruction and a second group of the first movable objects that have carried out the first instruction and are located rearward of the first movable object that does not carry out the first instruction.

9. The information processing system for movable objects as claimed in claim 1, further comprising a second determining section determining whether there is a first movable object in the row of the plural first movable objects that does not carry out the first instruction,
wherein if the second determining section determines that there is a first movable object in the row of the plural first movable objects that does not carry out the first instruction, the signal sending section sends a third signal including a third instruction to perform a predetermined notifying action to the first movable object that has carried out the first instruction and is located rearward of the first movable object that does not carry out the first instruction.

10. The information processing system for movable objects as claimed in claim 2, further comprising a second determining section determining whether there is a first movable object in the row of the plural first movable objects that does not carry out the first instruction,
wherein if the second determining section determines that there is a first movable object in the row of the plural first movable objects that does not carry out the first instruction, the signal sending section sends a third signal including a third instruction to perform a predetermined notifying action to the first movable object that has carried out the first instruction and is located rearward of the first movable object that does not carry out the first instruction.

11. The information processing system for movable objects as claimed in claim 5, wherein the signal sending section sends the first signal, the second signal or the third signal before the second movable object runs into an intersection that is the movable object stopping prohibited area.

12. An information processing method for movable objects comprising;
an information receiving process of receiving information on a distance L_{d} from a rear end of a most rearward first movable object located most rearward in a row of plural first movable objects on a road to a movable object stopping prohibited area and a length l_{V} of a second movable object that is stopping or scheduled to stop behind the most rearward first movable object;
a determining process of determining whether the distance L_{d} and the length l_{V} that are received by the information receiving section meet a predetermined condition; and
a signal sending process of sending the plural first movable objects forming the row on the road a signal including a first instruction to instruct the plural first movable objects to shorten a gap distance between the first movable objects next to each other to a first distance, if the determining process determines that the distance L_{d} and the length l_{V} meet the predetermined condition.

13. An information processing method for movable objects comprising;
an information receiving process of receiving information on a distance L between two movable object stopping prohibited areas on a first road between which there is a row of plural first movable objects at a stop on the first road, a length l_{VX} of each of the plural first movable objects and a width l_{W} of a second movable object running on a second road that is attempting to run into the first road crossing the second road;
a determining process of determining whether the distance L, the lengths l_{VX} and the width l_{w} that are received in the information receiving process meet a predetermined condition; and
a signal sending process of sending the plural first movable objects a first signal including a first instruction to instruct the plural first movable objects to shorten a gap distance between movable objects next to each other to a first distance to make a gap wider than the width l_{W} in an entering area to the first road so that the second movable object is able to run through the gap into the first road, if the determining process determines that the distance L, the lengths l_{VX} and the width l_{W} meet the predetermined condition.
